(19) United States
(12) Patent Application Publication
(10) Pub. No.: US 2023/0140931 A1
(43) Pub. Date: May 11, 2023

(54) CENTRALIZED PRACTICE PORTAL WITH MACHINE LEARNING CLAIM PROCESSING

(71) Applicant: eAssist, Inc., American Fork, UT (US)

(72) Inventors: James Victor Anderson, American Fork, UT (US); Jason Orgill, Idaho Falls, ID (US); Alexis Ryan Ashley, Queen Creek, AZ (US); James C. DiMarino, Ocean City, NJ (US); Tiffany Sue Wesley, Overland Park, KS (US); William Charles Blair, Charlotte, NC (US); Greg Nelson Grobmyer, Signal Mountain, TN (US); Lindsay Salazar, Syracuse, UT (US); Julie Devinney, Mt. Holly, NC (US); Tammy FriedmanLebo, Fate, TX (US); David A. Brinton, Herriman, UT (US); G. Keith Crofts, Pleasant Grove, UT (US)

(21) Appl. No.: 17/937,192

(22) Filed: Sep. 30, 2022

Related U.S. Application Data
(63) Continuation-in-part of application No. 17/664,386, filed on May 20, 2022.
(60) Provisional application No. 63/250,834, filed on Sep. 30, 2021.
(60) Provisional application No. 63/191,283, filed on May 20, 2021.

(51) Int. Cl. G06Q 40/08

(52) U.S. Cl. CPC G06Q 40/08

(57) ABSTRACT

Systems and methods are described herein for processing claims using rules engines based on specified conditions. A machine learning model may be trained using the outcomes of the claims processed using the rules engine. A trained machine learning system may be used in addition to or instead of the rules engine to process claims, estimate a likelihood of payment, and/or suggest modifications that will increase the likelihood of payment and/or the timeliness of payment.

### RELATED APPLICATIONS

This application claims priority to U.S. Provisional Patent Application No. 63/250,834 titled “Centralized Interactive Monitoring, Tracking, and Alert System to Increase Efficiency Between Disparate Operating Systems” and filed on Sep. 30, 2021, which application is hereby incorporated by reference in its entirety.

This application is also a Continuation-In-Part of U.S. patent application Ser. No. 17/664,386 titled “Coverage Analysis Based on Individual Patient Singular/Series Array Data Aggregated from Disparate Databases” and filed on May 20, 2022, which claims priority to U.S. Provisional Patent Application No. 63/191,283 titled “Coverage Analysis Based On Individual Patient Singular/Series Array (SSA) Data Aggregated From Disparate Databases” and filed on May 20, 2021, which applications are hereby incorporated by reference in their entireties.

### TECHNICAL FIELD

This disclosure relates to dental, medical, veterinary, insurance, legal, and other industries in which patients or clients are billed for goods and services provided by a professional in the field.

### BRIEF DESCRIPTION OF THE DRAWINGS

FIG. 1 illustrates an example of a treatment plan, according to one embodiment.

FIG. 2 illustrates a block diagram of communication channels between a general dentist and two specialists, according to one embodiment.

FIG. 3 illustrates an example of another treatment plan, according to one embodiment.

FIG. 4 illustrates a block diagram of an interaction between an insurance company and a general dentist, according to one embodiment.

FIG. 5 illustrates a block diagram of interactions between multiple parties, according to one embodiment.

FIG. 6 illustrates another block diagram of interactions between multiple parties, according to one embodiment.

FIG. 7 illustrates a matrix of singular/series arrays (SSA), according to one embodiment.

FIG. 8A illustrates a block diagram of interactions and communications to aggregate data to generate individual patient or client SSAs, according to one embodiment.

FIG. 8B illustrates another block diagram of interactions and communications to aggregate data to generate individual patient or client SSAs, according to another embodiment.

FIG. 9A illustrates an example of a treatment plan presenter (TPP), according to one embodiment.

FIG. 9B illustrates an example of another treatment plan presenter (TPP) with co-pay ranges based on associated trust scores, according to one embodiment.

FIG. 10 illustrates a block diagram of one implementation of various embodiments of the system described herein, according to one embodiment.

FIG. 11 illustrates a co-pilot portal computing system, according to one embodiment.

FIG. 12 illustrates a block diagram of co-pilot portal computing system interacting with a dental office practice management system, according to one embodiment.

FIG. 13 illustrates a block diagram of a claim scrubber system with conditions-based rules engine processor, according to one embodiment.

FIG. 14A illustrates a block diagram of a machine-learning claim scrubber system of a co-pilot portal system, according to one embodiment.

FIG. 14B illustrates a block diagram of a claim scrubber system with a conditions-based rules engine processor used to train a machine learning model, according to one embodiment.

### DETAILED DESCRIPTION

There are several fields in which the various embodiments described herein can be utilized including but not limited to: medical, dental, veterinary, insurance, legal, etc. The presently described systems and methods address various bottlenecks and difficulties faced by (1) patients when attempting to receive treatments with a high level of cost predictability and (2) dental offices attempting to manage patient expectations, process claims, and receive payment for services from all involved parties. For example, the presently described systems methods address various bottlenecks and difficulties faced by providers when trying to accurately predict the costs and insurance coverage for particular treatments for a particular patient, receive payments for treatments from insurance companies, and generally perform these functions in a predictable and transparent manner. Various embodiments of the system described herein are referred to as the co-pilot portal (CPP), which includes various subsystems that may, optionally, be implemented as stand-alone systems or modules separate from the combined co-pilot portal system.

The presently described systems and methods have been developed after reviewing tens of thousands of dental claims, third-party payor agreements, and patient co-pay obligations from hundreds of dental offices during the past ten years. The systems and methods described herein address numerous challenges, hurdles, inefficiencies, incompatibilities, and other “bottlenecks” that are faced by patients, dental offices, and insurers. Thirteen specific bottlenecks are described and addressed herein. However, it is appreciated that the bottlenecks explicitly described herein may be conceptually divided into sub-bottlenecks and/or combined into multi-issue bottlenecks, which the systems and methods described herein still address. Additionally, an expansion subsystem or module allows for the flexibility to increase the efficiency of the system and/or for the addition of new modules and subsystems to address new bottlenecks or other issues that are actively being investigated and will inevitably be discovered in the future. As such, the flexibility and adaptability of the presently described system is itself a noteworthy aspect.

Existing “solutions” and approaches to the problems described herein are inefficient and/or otherwise unacceptable with respect to claims processing, communication, claim adjudication, patient communication, quotes, insurance preauthorization, etc. which necessitates the need for systems described herein.

Some aspects of the solutions described herein are business and process solutions. However, other aspects of the systems and methods described herein are technical solutions and implementations of hardware devices that change the current use server-client interactions. For example, the presently described systems and methods reduce the number of interactions between client devices and server devices and increase the efficiency of such interactions by collecting the data needed without obtaining extraneous information. One practical application attained through the implementation of the presently described systems and methods is that the entire client-server architecture is modified to accommodate the co-pilot portal intermediary system. However, as described herein, the intermediary system implements new functionalities and interconnections that did not previously exist between the insurance servers and dental office end user devices.

For example, existing systems, approaches, and solutions often require a dental office to call a patient's insurance carrier to verify eligibility, confirm benefits, obtain a breakdown of coverage, confirm receipt of submitted claims, review or appeal insurance denials and adjustments, obtain or receive an explanation of benefits (EOB), integrate information into existing practice management software (PMS) systems for balance billing, track office aging reports to ensure full payment is received from an insurance carrier (and from the patient), and/or otherwise interact with an insurance company (or another third party payor). In some embodiments, the CPP system may screen scrape or otherwise access an insurance carrier's eligibility portal to verify insurance eligibility. The CPP system may mine, extract, or otherwise convert data from EDI 835 transactions, such as those involving claim payments or other remittance advice. The CPP system may also process (e.g., mine, extract, convert, etc.) EDI 270 health care eligibility/benefit inquiry transactions.

Manually calling each insurance company and/or entering data into various computer systems is time-consuming, laborious, and is highly susceptible to human error. Although the dental patient may provide the dental office with an insurance card, an insurance card often does not provide the level of detail the dental office requires to accurately verify and estimate the patient's and insurance carrier's(s') financial obligations. Accordingly, the dental office must still complete the investigation outlined above.

Currently, dental offices must verify a patient's benefits before they can present the patient with a treatment plan that outlines the respective financial responsibilities of the insurance carrier and patients. Often, this is a manual process that requires time and attention to detail by the dental office operator and numerous encounters with both insurance companies. The process is further complicated when all or some of the treatment options are provided by independent dental specialists in other offices. For example, a course of treatments may involve an oral surgeon, an endodontist, and a general dentist. Existing systems and approaches require manual coordination between one or more insurance companies and the offices of each separate practitioner.

If any errors are made in the manual entry of the information obtained from an insurance carrier or the patient into the dental office's computer or PMS system, the dental office operator may unknowingly provide the patient with erroneous financial projections that may not become evident for days, weeks, or months. This error puts the dental office operator in a bad position with the patient when a balance is discovered to be owed. In many instances, the dental office may choose to write off the balance to avoid damaging the relationship with the patient (e.g., to avoid causing the patient to distrust the dentist or other health care providers).

Alternatively, or additionally, the dental office may also decide to contact the patient's insurance carrier(s), request an appeal, or express their distrust, frustration, and/or anger for the misinformation the carrier provided which caused the distrust between the patient and the provider. The insured may also contact a governmental agency (such as a Department of Insurance), a regulatory body, or an industry watchdog to file a formal complaint. The dental office and the insurance company(ies) must negotiate to convince the other who should either pay or write off the disputed fee. Depending on the outcome of such negotiations and identification of fault, the dental office may lose confidence and trust in the insurance company(ies), their dental provider, and/or terminate their participation with the carrier and/or choose to find another dentist.

Further complicating the process, in some instances, a patient may have a secondary dental insurance policy and/or a primary and/or secondary medical insurance policy. The dental office must invest additional time/resources into presenting a treatment plan that represents the primary/secondary dental/medical insurance payments as well as the patient's obligation for the treatment the dental office and/or the treatments any specialist(s) will offer. It is readily apparent that presenting accurate cost predictions or quotes using existing systems and methods is a time-consuming and difficult process. With a single insurance plan, a patient may have a co-pay that they must pay; however, with multiple insurance plans (e.g., multiple dental plans and/or health insurance plans that cover part of a procedure), the amount left owing by the patient may be referred to as a patient responsibility or patient obligation.

The bottlenecks described herein delay and/or complicate the ability of the dental office to properly inform the patient of their financial obligations, preauthorize treatments with an insurance company, determine insurance coverage, and facilitate insurance payments and collections from all parties. In dentistry, for example, there are often many ways to treat a problem. A tooth may have decay that requires a filling. By way of example, a filling could be made of gold, a tooth-colored material, amalgam, or another material. The dental office may be required (ethically or legally) or desire to offer the patient treatment options, explain the differences, and provide the costs associated with each option. The dental office may share the prices and insurance coverage for different treatment options so that the patient will know what the out-of-pocket costs would be and how much of their insurance benefits they may be exhausting.

Using the example above, the out-of-pocket cost (after all insurance payments) for a tooth filling may be $100 for gold, $15 for tooth-colored, or $5 for the amalgam. The patient may evaluate their options and decide which treatment option is best for them based on what they want and can afford. If a patient opted for gold but then learned that it would cost them $100 out of pocket vs $15 for the tooth-colored restoration, they may select to receive the tooth-colored filling.

The bottlenecks described herein often prevent dental offices from accurately or quickly determining the insurance coverage and out-of-pocket patient costs. This may lead the dental office to present the options in vague financial terms using phrases like “most expensive,” “more expensive,” and “least expensive.” This may cause the patient to select an amalgam filling since it is the least expensive option. Whereas, if the dental office can easily offer all three options with exact, accurate cost information, the patient may decide the increased out-of-pocket costs of $10 to get a tooth-colored restoration is the “best” option for them, since they would prefer to have a tooth-colored filling rather than a dark filling and the minimal increase in cost is worth it to the particular patient. The same patient may prefer the gold filling but decide that gold is not worth the $100 co-payment and settle for the tooth-colored filling with the $15 co-pay.

Currently, it is exceedingly difficult and often unpredictable to overcome the many hurdles dental offices face for each patient they treat each day. The presently described systems and methods address and overcome each of the identified bottlenecks. The presently described systems and methods allow a dental office to efficiently provide an accurate estimate of what one or multiple insurance plans will pay for treatment at one or multiple providers' offices, know what documents must be included and how the claim should be submitted to the insurance carrier, manage the claim submission/downgrade/appeal process, and provide other features, benefits, and functionalities, as described herein.

The systems and methods described herein allow the dental office to efficiently provide information sufficient for patients to know if emergent care will be financially feasible and how much insurance will pay in an entire benefit cycle so that the patient can address their non-emergency needs, emergency needs, and long-term needs in a predictable manner. As stated, the systems and methods described herein are applicable to many disciplines. However, dentistry is used in many examples and embodiments to illustrate the various benefits and functionalities.

Many embodiments of the presently described systems and methods include a centralized monitoring, tracking, and alert system. In various embodiments, the system pulls data from and inputs data into disparate operating systems. The CPP system is expandable, scalable, and self-learning. Various artificial intelligence and/or machine learning applications are described herein, along with a unique machine learning architecture.

As an example, an architecture may include a claim scrubber system with a rules engine and input conditions claims cleaning and processing. The claim scrubber system may utilize the rules engine and specified conditions while a machine learning model is being trained. The machine learning mode may receive as inputs, the original claims, the payment (or non-payment) outcome of processed claims, the time between claim submission and payment, and other claims submission and processing information described herein.

In one architecture, a trained machine learning model may operate as a stand-alone claim scrubber system to provide (1) a predicted payment outcome, (2) the expected timing of payment, (3) a recommendation to modify the claim to increase the likelihood of payment, and/or (4) a recommendation to modify the claim to decrease the expected timing of payment (e.g., recommendations to modify the claim that will results in quicker processing and payment by the insurance companies. In some embodiments, the claim scrubber system may provide a list of recommended modifications that could be made to the claim to increase the likelihood or timeliness of payment. The modifications may be presented to a human for modification and/or to a rules engine with specific conditions for modifying a claim.

For example, the claims scrubber system may indicate that adding the age of the patient will increase the likelihood of payment. As a factual piece of information available from a linked patient information database, the rules engine subsystem may determine that the patient's age can be automatically added to the claim without human intervention. The system may modify the claim to include the patient's age and submit it for processing (or for re-analysis). The machine-learning model of the claim scrubber system may recommend other changes that are flagged by the rules engine as requiring human review prior to claim modification.

In the various examples described herein, the first insurance carrier is sometimes referred to herein as “I1” and the dental office is sometimes referred to as “DO”. In some instances, a patient may have a secondary dental insurance carrier sometimes referred to as “I2” and primary and/or secondary medical insurance carriers or additional source(s) for which one may need to review and/or coordinate benefits, sometimes referred to herein as “I3,” etc. A dental office will often connect with first insurance carrier, and/or second insurance carrier and/or additional insurance carriers to verify if the patient has dental and or medical insurance coverage, the effective date of said insurance, obtain the insurance benefit details, and coordinate benefits between primary and secondary dental and/or primary and/or secondary medical benefits if desired.

According to various embodiments, the systems and methods described herein may track credits and debits associated with each patient to ensure that credits and refunded money (e.g., as part of an appeals process or reimbursement) are given to the patient. In some instances, the system may automatically generate an unclaimed property report with the state government officials if the patient cannot be reached to receive a credit on an account.

Although the dental patient may provide the dental office with an insurance card, it often does not provide the level of detail dental office requires to accurately verify and estimate the patients' and insurance carriers' financial obligations.

Therefore, dental office must contact the first insurance carrier to receive the necessary information via one or more data retrieval sources, such as via email, phone call, a fax back, etc., all of which are helpful but require an investment of time by dental office and may still result in a lack of required information to proceed which causes the cycle to repeat until the discovery is complete.

Another problem inherent in the current process is imparting errors. If the data exchanged between a dental office and a first insurance carrier, a second insurance carrier, and/or a third insurance carrier is out of date or subjected to human error, the patient and insurance billing estimates may be wrong. These billing errors can cause frustration, anger, and distrust between the patient, the dental provider and/or the insurance carrier(s) and often results in one of the three feeling like they were forced to overpay.

Currently, dental offices must verify their patients' benefits before they can present their patients with a treatment plan which outlines the insurance and patients' financial responsibilities. Often, this is a manual process which requires time and attention to detail by the dental office operator and numerous encounters with first insurance carrier, second insurance carrier, and/or third insurance carrier+.

If any errors are made in the manual entry of the information obtained from the first insurance carrier, the second insurance carrier, etc. (e.g., as manually entered into a ledger, database, computer system, file, or other repository), the dental office operator will unknowingly provide their patient with erroneous financial projections. The mistake may not become evident for days, weeks, or months. This error puts the dental office operator in a bad position with the dental office patient when a balance is discovered to be owed which often results in the dental office writing off the balance while also causing the patient to distrust their health care provider. Alternatively, the dental office may contact the first insurance carrier, the second insurance carrier, and/or the third insurance carrier, etc. to contest, request an appeal, or express their distrust, frustration, and/or anger for the misinformation. The dental office and the insurance company(ies) must negotiate to convince the other who should either pay or write off the disputed fee and, depending on the result, could lead to the dental office not trusting the insurance company(ies) and terminating their participation.

If the dental office operator determines that the error was the fault of incorrect information provided by the first insurance carrier, the second insurance carrier, and/or the third insurance carrier, the first insurance carrier, the second insurance carrier, and/or the third insurance carrier must determine if they write off the error. Both of the aforementioned cases would benefit from accurate, real-time information being shared between the insurance company(ies), the dental office and the patient in a manner that avoids human interaction/error.

Even when accurate information can be exchanged, the policies regarding the interplay and payments of multiple insurance companies may not be clearly defined or established. In some instances, the only way to learn about how claims are processed by various insurance companies is by analyzing how the actual claims are processed. For example, two insurance companies may each state that they pay half of the cost of a crown; however, it may not be clearly defined what will happen if the patient is covered by both insurance companies. In one scenario, the first insurance company pays for 50% of the crown and the second insurance company pays the other 50%. In another scenario, the first insurance company pays for 50% of the crown, the second insurance company pays for 50% of the remaining balance, and the patient pays the remaining 25%. In another scenario, each insurance company may pay for 25% of the crown, leaving the patient to pay for the remaining 50%. Due to the complexity of insurance billing, the interactions between multiple dental and health insurance companies, and the overlapping coverage provisions of each individual coverage policy, it is sometimes not possible to determine an exact co-pay amount that will be owed by a patient by simply asking each of the insurance companies.

Another problem inherent in the current process is providing an estimate of coverage, costs, and the plan design as it relates to the treatment plan of a general dentist especially when the treatment plan includes a patient referral to one or more specialists. If a patient needs dental treatment of fillings, a root canal, extraction of wisdom teeth, etc., for example, it is the responsibility of the dental office to provide a treatment plan to the patient. The treatment plan must provide an option of treatments the dental office is recommending for the patient based on the examination and the patients' needs. The treatment plan may include work the dental office will complete as well as a referral to a specialist or specialists for work they will do such as a root canal specialist called an endodontist (S1) for molar root canals or a specialist that extracts impacted wisdom teeth called an oral surgeon (S2) for example. In cases where a specialist or group of specialists may be needed, the dental office will have to communicate with S1, S2, S3, etc., the endodontist, oral surgeon, and/or other specialists to determine how much their treatment is going to cost so the dental office can determine if the patients' insurance maximum can cover the most emergent dental treatment needed and how much will remain thereafter so the dental office can prioritize the patients' treatment. In various embodiments, the patient is provided with the information and options needed to avoid surprises, including surprises from specialists and other providers involved in a particular treatment—regardless of whether the patient is insured, insured by multiple insurance companies, or uninsured.

Currently, it is exceedingly difficult and often unpredictable to determine if a patients' insurance will cover emergent care especially if multiple providers are involved. If one also adds multiple insurance carriers, accurately predicting insurance and patient financial obligations becomes even more cumbersome. Therefore a need exists to create a system that can provide an accurate estimate of what one or multiple insurance plans will pay for treatment at one or multiple providers' offices so that a patient will be able to not only know if emergent care will be financially feasible but also to accurately determine how much insurance will pay in an entire benefit cycle so that the patient can address their emergency and long-term needs in a predictable manner.

As stated, the systems and methods described herein are applicable to many disciplines, however in order to provide an example of a possible application, an embodiment that pertains to the field of dentistry will be shared. The presently described systems and methods offer solutions that utilize computer mapping technologies to combine information from multiple insurance companies and/or multiple providers to aggregate data from disparate databases, individuals, fax back records, email requests, etc. Singular series arrays (SSAs) are used as a data structure to store and provide access to aggregated data. In some embodiments, machine learning and artificial intelligence subsystems are used to estimate the costs associated with various treatment plans. Calculated values and other data may be compared with processed claims stored in a database to see if the calculated results are harmonious with past results of historical processed claims stored in a processed claim database.

A trust score may be associated with each estimate of costs and the final cost presented to a patient may include a trust score. In other embodiments, the trust score may be used to provide a range of possible payments associated with a treatment plan based on trust score thresholds. For example, a trust score information may be used to provide a worst-case scenario of the total cost assuming that the expected costs with a trust score above a threshold value (e.g., 75) are accurate and a best-case cost estimate assuming that estimated insurance coverage associated with lower trust scores are paid. Some insurance coverage estimates may be in the form of a minimum coverage estimate with a trust score of 100 (maximum) and an expected or possible coverage estimate with a lower trust score (e.g., 50), and an expected or possible coverage estimate with an even lower trust score (e.g., 25). In such an embodiment, the coverage estimate provided in a treatment plan to the patient may include a best-case scenario that includes all three possible payment/coverage outcomes.

Insurance companies create insurance packages which they offer to employers outlining what the insurance will cover for each of the hundreds of American Dental Association's Current Dental Terminology (hereafter “ADA CDT”) codes. In order for the employer to make an informed decision for their employees, the insurance companies offer a breakdown of benefits, maximum allowable charges, deductibles, maximum benefits, etc. (hereafter “Plan”) with great specificity. Once the employer decides which insurance Plan to purchase, the role of the insurance company is to administer the Plan benefits that the employer purchased. In order to do so, the insurance company must follow a specific set of standards (Plan) that is outlined in the insurance policy which the employer purchased.

Dental offices review their patients' plan to determine what their patients' insurance will cover in order to help their patients know how much their dental Plan will cover for the dental treatment and what the patients' financial obligation will be.

The systems and methods described herein allow the dental office to connect with first insurance carrier, second insurance carrier, and/or third insurance carrier, etc. in a manner that allows the dental office to clearly verify their patient's insurance eligibility and benefits as well as the plan details so an accurate estimate of the financial obligations of all parties can occur in real time without the need to contact the insurance company(ies) repeatedly and/or speak with an insurance company or companies' representative who could introduce human error unknowingly and unintentionally.

In various embodiments of systems and methods described herein, the dental office's infrastructure is modified to seamlessly sync/access the insurance company(ies) Plan without the need for human involvement/possibility of human error using Dynamic Custom Logic (hereafter “DCL”).

The reason the DCL process is so unique is that it simplifies the following process that is currently used: an employee or employees at the dental office must invest significant time to connect with at least one or more insurance company(ies) before each of their patients' dental appointments in order to verify the patients' insurance and obtain the Plan details to sync the dental office patient's benefit details into dental office's practice management software system or Office Record Keeping System (hereafter “ORKS”) without introducing human error. Additionally, if the dental office determines that the patient is in need of specialist services, an employee or employees at the dental office must invest significant time to connect with at least one or more specialists' offices to gain clarity on the costs of the specialty treatment and then connect with the insurance company(ies) before each of their patients' dental appointments in order to verify the patients' insurance and obtain the Plan details.

In various embodiments of the systems and methods described herein, the dental office is provided with the most up to date information needed to allow the dental office to provide their dental and/or medical insurance company(ies) anticipated payment so the dental office can provide the patient with their financial obligation based on the treatment needed and the allowable/eligible insurance remaining as accurately provided by the insurance company(ies) in real time, in a learning environment, while also avoiding the introduction of human error.

The DCL can be utilized to sync whatever information is desired between one, two, or more users. This synchronous interaction is free of human interaction and greatly increases the efficiency of all users while also decreasing the risk of requiring any party to write off a balance. This enhances the patient's experience and instills confidence in the patient-healthcare provider relationship since the amount the patient was projected to owe for the treatment is in fact the amount the patient paid. Additionally, this improved process allows the patient to maximize their legitimate insurance benefits across multiple insurance carriers as well as providers so the patient can obtain the best possible treatment available.

In some embodiments of the systems and methods described herein, the DCL can include a singular or a series of arrays (hereafter “SSA” for Singular/Series of Arrays) that allow for further customization. Array #1,for example, might be used to populate a patient's primary dental insurance. If the patient also has a secondary dental insurance, another array would be created. Additionally, a third, fourth, or more array(s) may be created to include the patient's primary and secondary medical insurance or as many arrays as is needed.

A Code Compilation Component (hereafter “CCC”) may be a system, a subsystem, or a module that allows the DCL to work with the SSA to provide an estimate of coverage wherein the coordination of benefits occurs. The CCC overcomes one of several hurdles in the patient verification and insurance estimate environment by estimating what a patient's primary/secondary dental insurance and/or primary or secondary medical insurance (for example) may pay and what the patient's obligation will be.

Currently, many patients who have dual coverage and/or medical and dental coverage rarely coordinate benefits which means they either pay too much for a procedure or avoid a procedure thinking their co-pay may be too expensive. The DCL and the CCC combine to overcome these challenges by coordinating both primary and secondary dental and medical insurance so that the patient maximizes their insurance coverage, only pays the appropriate amount required, and can then make an informed decision to proceed or not with treatment based on the medical/dental benefit. This embodiment also allows the dental office and patients to track their use of insurance so that by October or November of each year, they can easily determine how much of their insurance has been unused and can plan treatment so that the patient can maximize their yearly insurance benefits and the dental office can maximize their Q4 operations.

There are many fields to which the embodiment can be applied, below describes how the embodiment may be implemented in the field of dentistry.

A specific example of a potential use case for the system defined herein, is explained next in the field of dentistry with the assistance of drawings. In the field of dentistry, each treatment has an American Dental Association Current Dental Terminology Code (hereafter “ADA CDT”) assigned to the procedure which starts with the letter D and to which insurance companies and dental providers assign/charge a fee. In this example,

(a) A new patient enters a general dentists' office seeking dental care

(b) The dental office provider examines the patient which will be recorded using the ADA CDT code D0150—Comprehensive Oral Exam.

(c) The dental office provider orders a Full Mouth Series of Radiographs (D0210)

(d) The dental office provider completes an adult prophylaxis otherwise known as a “dental cleaning” (D1110) and creates a treatment plan which includes the following:
(di) Extraction of an impacted wisdom tooth #1 which is causing the patient pain, is infected, and swollen for which the patient has requested the use of General Anesthesia (D9222 and D9223).
(dii) Tooth #2 is infected, painful, and the gum around it is swollen.
   (dii1) For each finding, a dental office provider is required to offer their patient treatment options so the patient can determine which solution is best for them. We will use tooth #2 to show how this often plays out between a patient and the dental office. Here are the two options presented to the patient:
      (dii1a) Option 1: Root Canal Treatment (hereafter “RCT”) due to pain, infection, and swelling. (D3330).
      (dii1b) Option 2: Extraction due to pain, infection, and swelling. (D7140 or D7210).
   (dii2) Often, the patient will ask:
      (dii2a) What does my insurance cover for the RCT?
      (dii2b) How much will I have to pay for the RCT?
      (dii2c) If my insurance covers the RCT and I only have to pay $1 or less, I want to keep tooth #2 and will choose the RCT option.
      (dii2d) If my insurance does not cover a RCT, I want it extracted.
(diii) Crown on tooth #3 (D2740)
   (div) Onlay on tooth #4 (D2642). The patient decided they will agree to the onlay only if their insurance covers it and their co-pay is less than $1.
   (dv) One-Surface Posterior Composite Filling on tooth #5 (D2391)

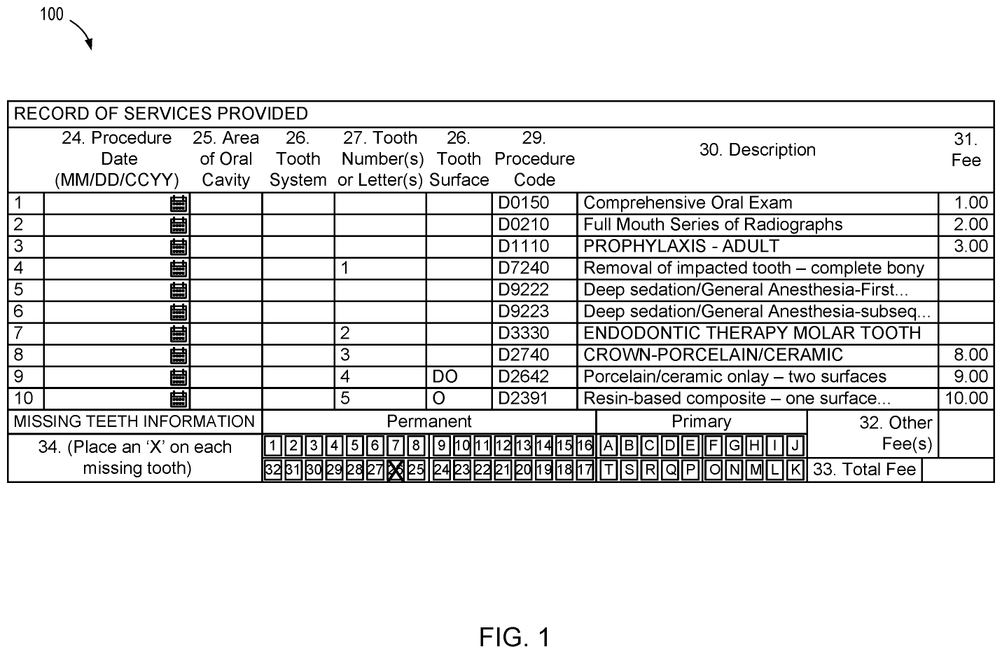

FIG. 1 illustrates an example of a treatment plan 100, according to one embodiment. There are several steps the dental office must then take to be able to answer the patient's questions. The first thing is to input the aforementioned treatment into their ORKS which would produce a treatment plan 100 as illustrated.

The dental office provider may decide to refer the patient to a specialist or specialists for certain procedures. In this case, the dental office provider has elected to refer the patient to an Oral Surgeon (S1) to extract the impacted tooth #1 and to an Endodontist (S2) for a root canal treatment for tooth #2 if the patients' insurance company covers the RCT and the patient's co-pay is less than $1. If not, the provider will add the extraction of tooth #2 to the referral to S1. Since the dental office knows how much they charge for the treatment that will be rendered in their office, they can input the fees as shown in column #31 in the illustrated treatment plan 100.

In order to obtain the fees for the specialists, the dental office must contact the specialist(s) and provide the necessary patient documentation/information so the specialist(s) can share their fees for the treatments for which the dental office provider is referring the patient. NOTE: the dental office must get two fees from S1, one for the extraction of the impacted tooth #1 and one for the extraction of tooth #2 in case the insurance company does not cover the RCT for tooth #2 or the patients' co-pay exceeds $1. Various embodiments utilize a system for sharing and exchanging information with not only insurance carriers but also specialists so that this process can occur in real-time and be pulled into the dental offices' ORKS.

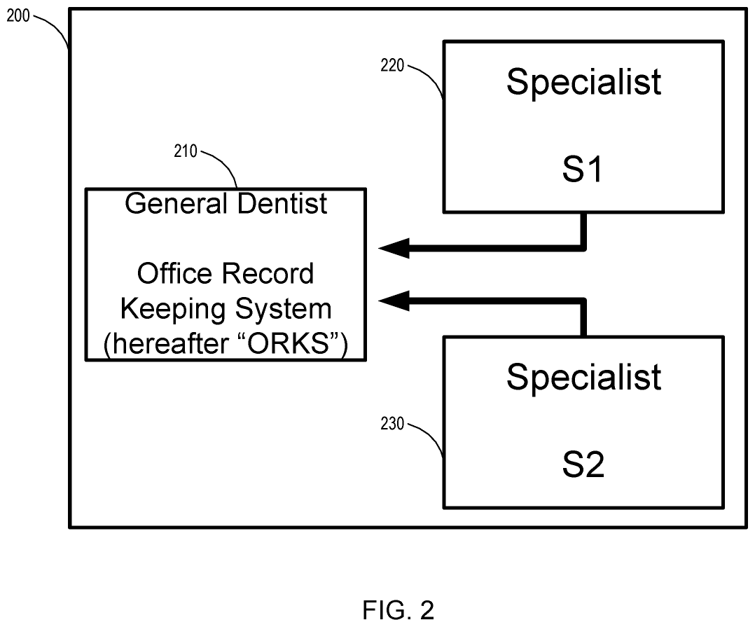

FIG. 2 illustrates a block diagram 200 of communication channels between a general dentist 210 and two specialists 220 and 230, according to one embodiment. The dental office 210 now may request the necessary information from each of the specialists 220 and 230 and add the information to their ORKS. To accomplish this objective, the dental office 210 must reach out to the specialists 220 and 230 via a specific S1, S2, etc., URL, API, or the dental office 210 must email, call or use a fax back system for EACH specialist 220 and 230. Once the dental office 210 inputs all the fees from the patient(s) specialist 220 and 230 into their ORKS, the dental office 210 can update their treatment plan.

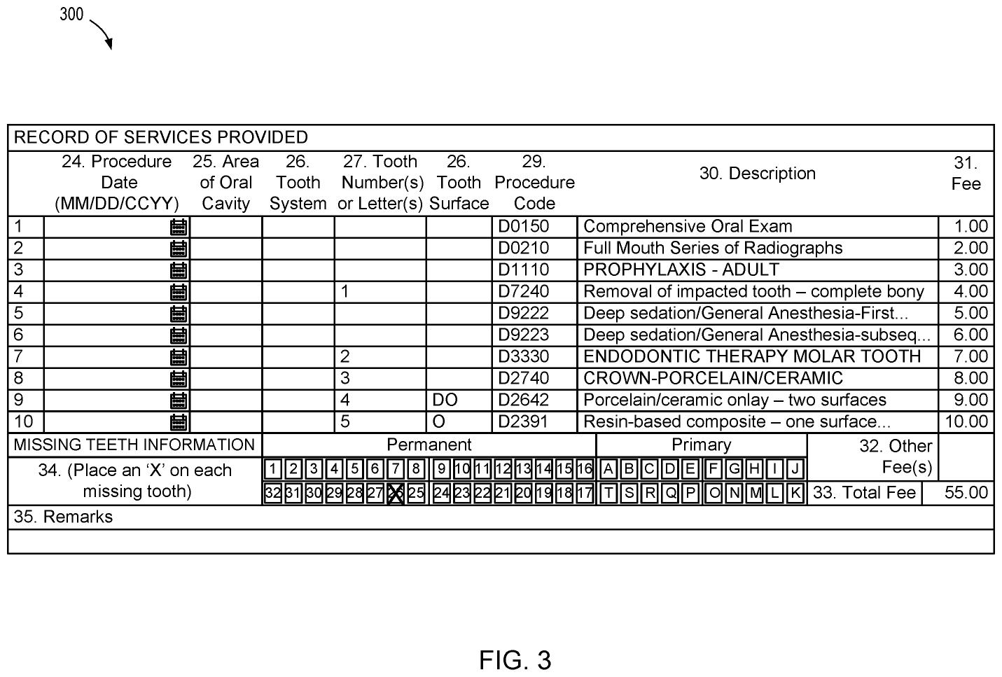

FIG. 3 illustrates an example of the updated treatment plan 300, according to one embodiment. As illustrated, relative to FIG. 1, the fees in column #31 in the treatment plan 300 shows the complete treatment plan with the fees from the specialists in place.

Now that the dental office has the treatment plan and the fees from the specialists and the general dentist, the dental office will then need to reach out to the insurance carrier(s) to obtain information, a few pieces of which is shared below:
(a) Verify that the patient does, in fact, have insurance coverage with the insurance carrier,
(b) When the patients' effective date started with the carrier
(c) Deductible
(d) Annual maximum
(e) what ADA CDT codes are covered and what the maximum allowable charge is
(f) Verify if medical insurance will cover the cost of anesthesia (identify CPT code)
(g) etc.

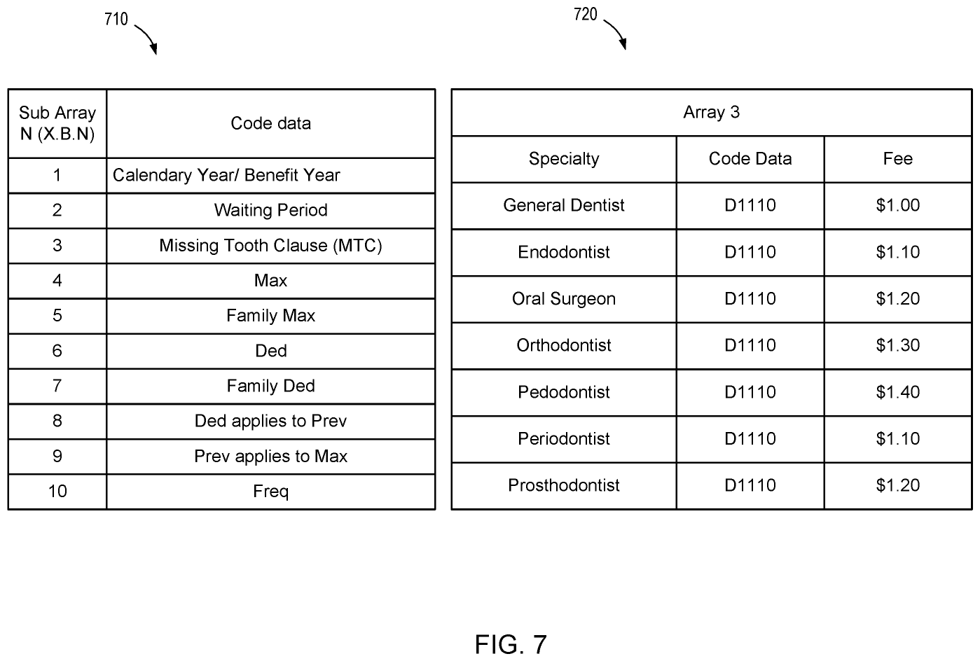

According to various embodiments, the system may utilize the information, including one or more of information items (a)-(f) above, to generate an array, such as the example array illustrated in FIG. 7, as described in great detail below.

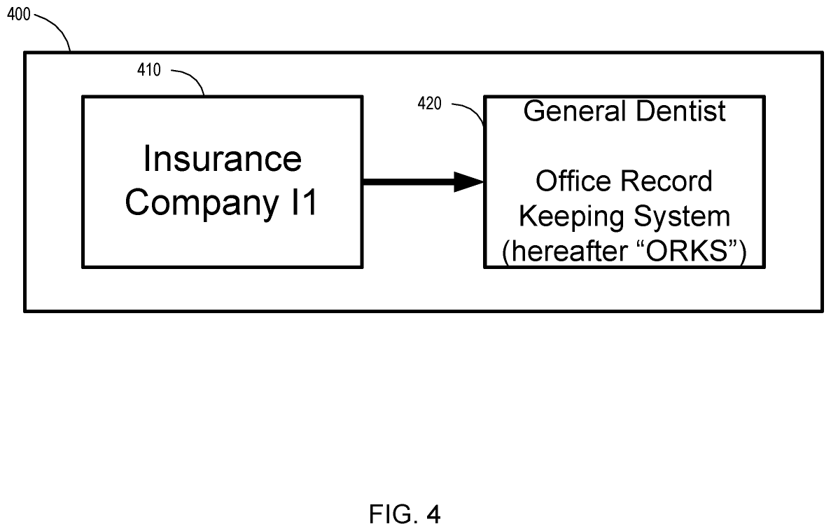

FIG. 4 illustrates a block diagram 400 of an interaction between an insurance company 410 and a general dentist 420, according to one embodiment. This basic connection is the current arrangement in most dental offices. Specifically, the information the dental office needs to obtain from the first insurance carrier must be added to a specific area in the dental ORKS, which currently occurs mostly manually.

In order for the dental office to get the necessary information into their ORKS, it must obtain the information from first insurance carrier via a specific first insurance carrier URL, API, or the dental office must email, call or use a fax back system which is often typed into the ORKS. The dental office must also be aware of the participation of the various specialists in the insurance coverage of each patient. If they specialists participate in a given insurance plan, the patient can expect the coverage and associated fees of the particular insurance. If the specialist is considered out of network, the patient's fee responsibility may increase significantly.

Coverage of secondary insurance may be carefully documented in predeterminations of coverage by a secondary insurance. Predeterminations may be used to hold the insurance company to their word to ensure that the patient's expected out of pocket costs match their actual charges after the procedure are performed.

As described previously, the process of obtaining the necessary information consumes employee(s) time and often introduces human error which may cause the insurance carrier(s), the dental provider, the specialist(s), and/or the patient to be forced to pay or write off any balances that were erroneously calculated due to errors in this process. Offices often rely heavily on humans manually scraping the information from the insurance carrier(s) and inputting it into their ORKS or on APIs or a hybrid thereof. If a dental office is also relying on APIs then bridges have to be created, updated, and managed for each dental insurance carrier to input the information into the dental office's specific ORKS and often only provide a snapshot of the data required which forces the dental office to pick up the phone to call the insurance carrier(s) to request the missing information.

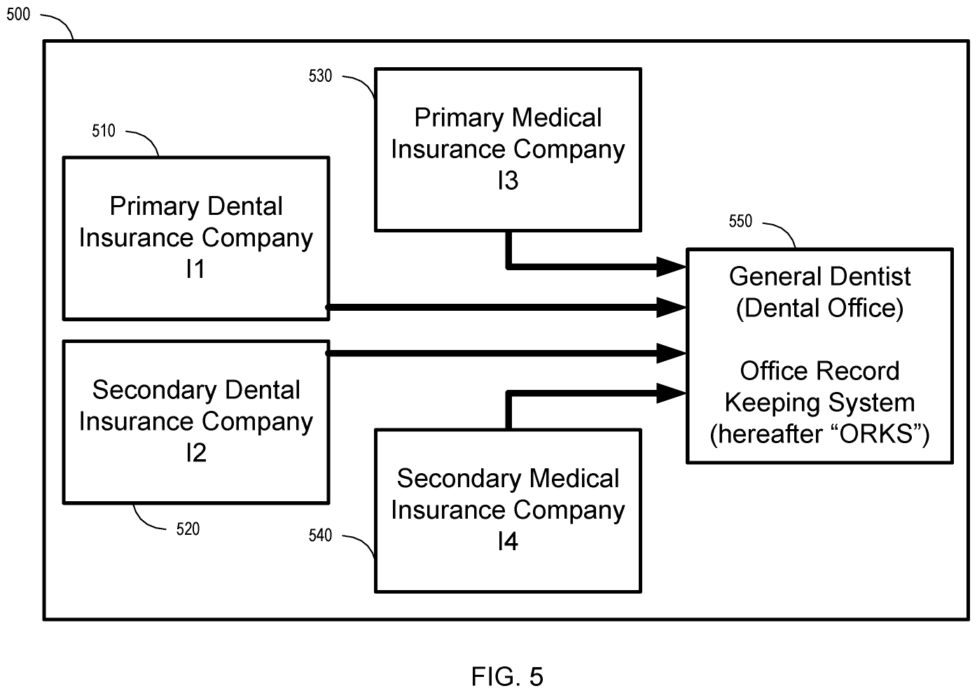

FIG. 5 illustrates a block diagram 500 of interactions between multiple parties, according to one embodiment. The process is more complex if a patient has multiple insurance carriers 510, 520, 530, and 540. Now, in order for the dental office 550 to get the necessary information into their ORKS, it must obtain the information from first insurance carrier 510, second insurance carrier 520, third insurance carrier 530, and fourth insurance carrier 540 via four (4) different, specific URLs for each insurance carrier, four (4) different APIs, or the dental office must email, call or use a fax back system four or more times.

This process is time consuming and could be fraught with human error which often results in inaccurate financial estimates, frustration, and delay or avoidance of completing necessary dental care. After the dental office 550 receives the required information from the specialists and the insurance carriers, the dental office must then review all the information.

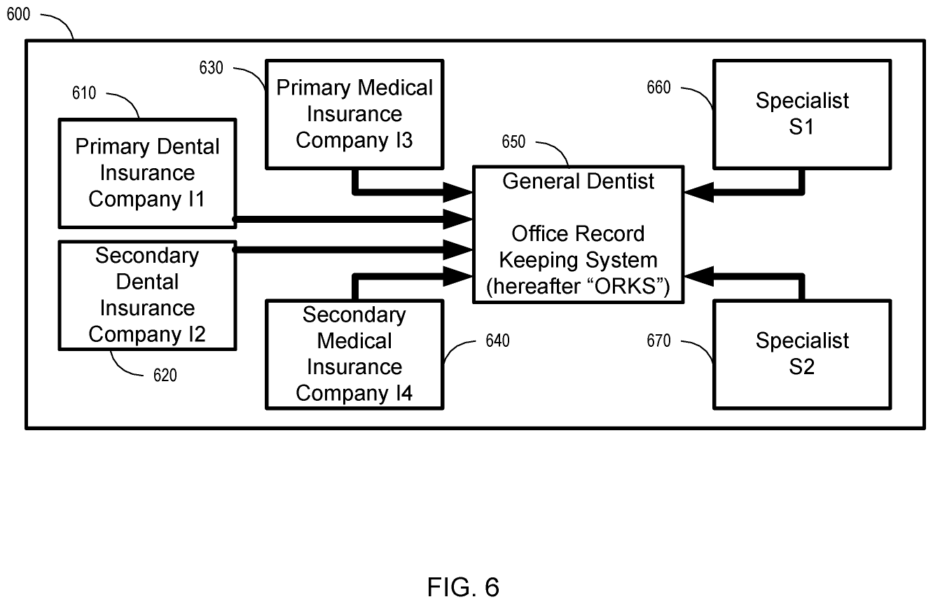

FIG. 6 illustrates another block diagram 600 of interactions between multiple parties 610, 620, 630, 640, 650, 660, and 670, according to one embodiment. As illustrated, a dental office 650 must analyze to determine what insurance will cover and what the patient's financial obligation will be so the dental office 650 can present a summary to the patient in a manner the patient can understand so the patient can determine which treatment options to select.

If any information from any of the sources is misunderstood, misinterpreted, or misconstrued by the dental office 650, the summary will be incorrect. If the summary is incorrect:
(a) the patient may elect a treatment option or choose not to have treatment based on this faulty summary.
(b) and the summary erroneously states that the patient's co-pay for the RCT is $3 which is over the patients' threshold, the patient may elect to extract the tooth when, in fact, the patients' co-pay was only $1 which is under the patients' threshold and means the patient could have saved the tooth with a RCT.
(c) because the dental office did not check with the patients' secondary dental insurance which would have covered the remaining balance of the RCT which the primary insurance did not cover, the patient would have had no co-pay for the RCT and would have saved more of their annual maximum which insurance would possibly pay toward additional treatment such as the crown on #3.
(d) the patient may be presented after completing treatment with a bill larger than what was initially estimated
   a. The patient may be upset, lose faith/confidence in the provider and dental office, may refuse to pay which may further corrupt the relationship, may leave a bad review on social media, may even initiate legal action against the insurance carrier and/or the provider, etc.
   b. The dental office may choose to write off the amount in question, pursue collection actions against the patient, or take action against the insurance company.
   c. If either or both the patient and/or provider contact the insurance carrier, report the insurance carrier to the state board, or take legal action against the insurance carrier, the carrier would have to investigate and may have a recording to review. Ultimately the insurance carrier could pay the provider if the recording in fact shows that the insurance agent provided false information, or, alternatively refuse to pay the provider if the agent did provide the correct information and the dental office representative misunderstood, misreported, or in fact made an error when inputting the information in to the dental office's ORKS.

This example shows how much work must go into obtaining the correct information from the insurance carrier(s), general dentist, and specialists and how critical it is that the information is correctly added to the dental office's ORKS. Even when all is done correctly, treatment options, insurance coverage, and patient co-pays need to be presented in a fluid, up-to-date, and easy to understand manner so the patient can make a treatment decision that is in balance between what they can afford and what they need/desire.

Therefore, it is important for a dental office to provide an accurate summary. If accurate, the summary can help the patient maximize their insurance coverage, treat as many oral concerns as possible, and know how much their co-pay will be for said treatment. Inaccurate summaries can also harm the patient by causing the patient to delay needed treatment due to the cost which could ultimately cause needless pain, suffering, and/or more extensive/expensive treatment due to the delay, in turn potentially impacting patient overall health.

Therefore, there is a need for a system that:
(a) Represents a design choice in which creating a self-learning technology was chosen over the current, flawed, and limited human-API hybrid.
(b) Provides a specific neural network architecture like a feedforward neural network, a convolutional neural network, a modular neural network (or other machine learning or artificial intelligent system)
(c) That continually learns and dynamically adapts to each dental office, insurance company, and specialist (such that each dental office experiences a uniquely trained system) and/or the system learns globally from all users such that all dental offices can experience the same benefits from a system that is continually improving.
(d) Overcomes the challenges dental offices now have even if they could create APIs to sync data in real time with the hundreds of insurance carriers, over 180,000 dentists in the USA alone, with the dozens of ORKS on the market so the dental office can summarize and present treatment plan options with a high degree of specificity, accuracy, and fluidity so patients can choose from several different treatment plans or different specialists in real time. Currently dental offices do not have an option to allow their ORKS to simply send an API request to the insurance company's API and or Specialists and get the information they need and if they could, they would have to create APIs for the hundreds of insurance carriers, thousands of specialists, and obtain and manage the information.
(e) Provides patients with options and prices for specialists within the geographic area of the general dentist so the patient can choose the specialist that provides the best pricing, best care, or a combination thereof.
(f) Creates arrays for each of the data sets that holds the required information to create the patient treatment plan based on which insurance the patient has.
(g) These arrays will house the data for each of the insurance plans and then be fed into an aggregator or the Code Compilation Component (hereafter “CCC”) which is then used to compile the information, learn from previous experiences, ask for human input when stuck so it can learn how to overcome the challenge in the future and present a treatment plan based on the output settings the dental office selects.
(h) dental office staff have not had the time, resources, technology, or the ability to do the many aspects of the systems described herein.
(i) The systems and methods described herein provide a technological solution that presents as an output which the patient can understand by dynamically providing treatment options since we have the ability to provide real-time data, options, and alternative scenarios.
(j) A user interface that provides usable information gathered from a matrix of all the arrays which allows us to dynamically produce the outcomes of how much the total treatment will cover, which is not currently possible to provide from a human.
(k) Utilizing the information collected to coordinate insurance benefits and accurately predict insurance and patient financial obligations.

FIG. 7 illustrates a matrix of singular/series arrays (SSA) 710 and 720 used to organize and arrange data aggregated from disparate databases that may communicate and store data using disparate protocols, languages, and the like, according to one embodiment.

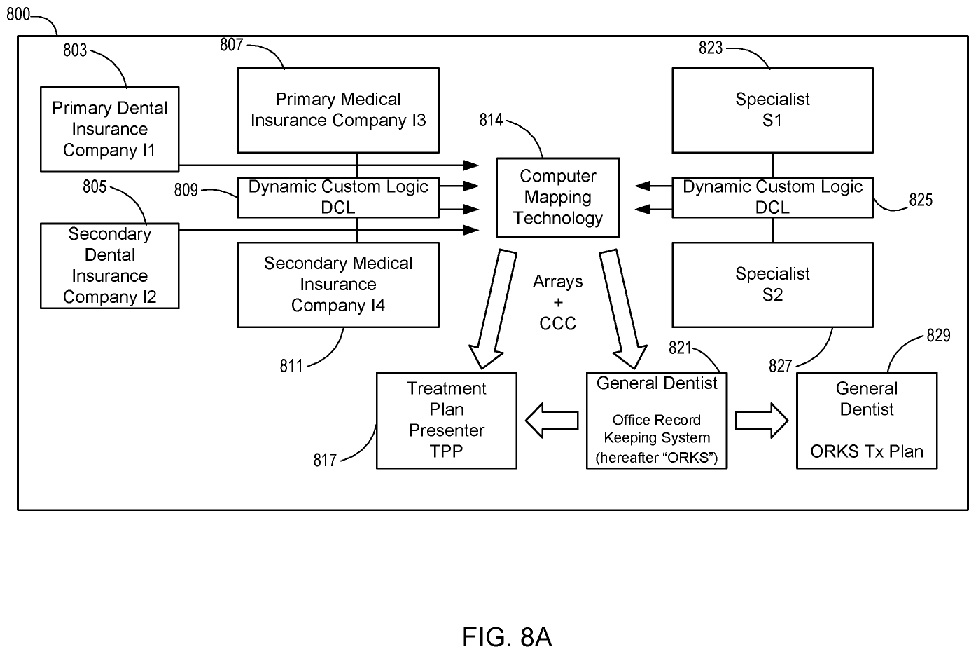

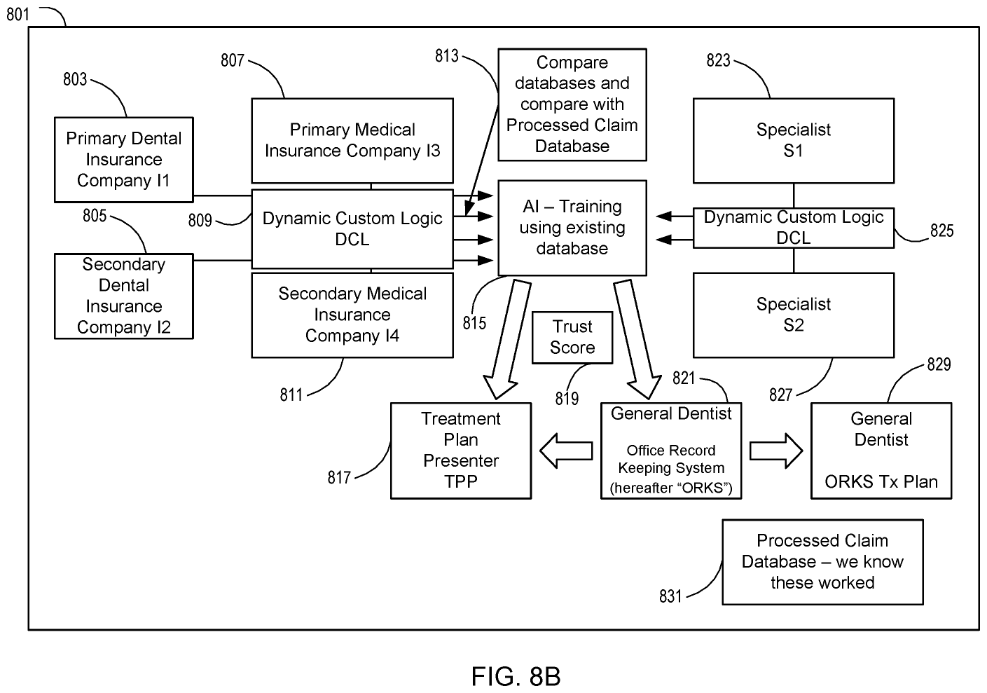

FIG. 8A illustrates a block diagram 800 of interactions and communications to aggregate data to generate individual patient or client SSAs, according to one embodiment. As illustrated, FIG. 8A shows an embodiment that may utilize CCC, computer mapping technology 814 (hereinafter “CMT”) and/or DCL 809 and 825 to synchronize, update, and exchange the data from insurance company(ies) 803, 805, 807, 811, and specialist(s) 823 and 827 into arrays, which are converted by the CMT 814 directly into a usable form for the dental office 821 and seamlessly inputted into the dental office's ORKS 829.

A treatment plan presented 817 can present the treatment plan with estimated costs and coverage amounts. This process is designed to occur in real time so the precise information is shared without human interaction and the chance of human error.

FIG. 8B illustrates another block diagram 801 of interactions and communications to aggregate data to generate individual patient or client SSAs, according to another embodiment. The illustrated embodiment utilizes a CMT 815 that incorporates or otherwise leverages artificial intelligence and machine learning. Information aggregated by the DCL 809 from the insurance companies 803, 805, 807, and 811 can be compared with databases, such as processed claim database 831 to verify the accuracy of the information and how well it comports or matches with the actual results of previously processed claims. Additionally, a trust score 819 may be generated by the CMT 815 based on the source of the information and/or how well it matches with previously processed claims.

The trust score 819 may be used to develop a treatment plan by the treatment plan presented 817. For example, data associated with a high trust score may be used with confidence to provide exact cost estimates. Data and calculations associated with a low trust score may be used with less confidence or included as a range when providing cost and coverage estimates. In various embodiments, a Treatment Plan Presenter 817 (hereafter: “TPP”) which may be embodied as a system, a subsystem, or a module, which allows the dental office to present the treatment plan in a clear, concise manner.

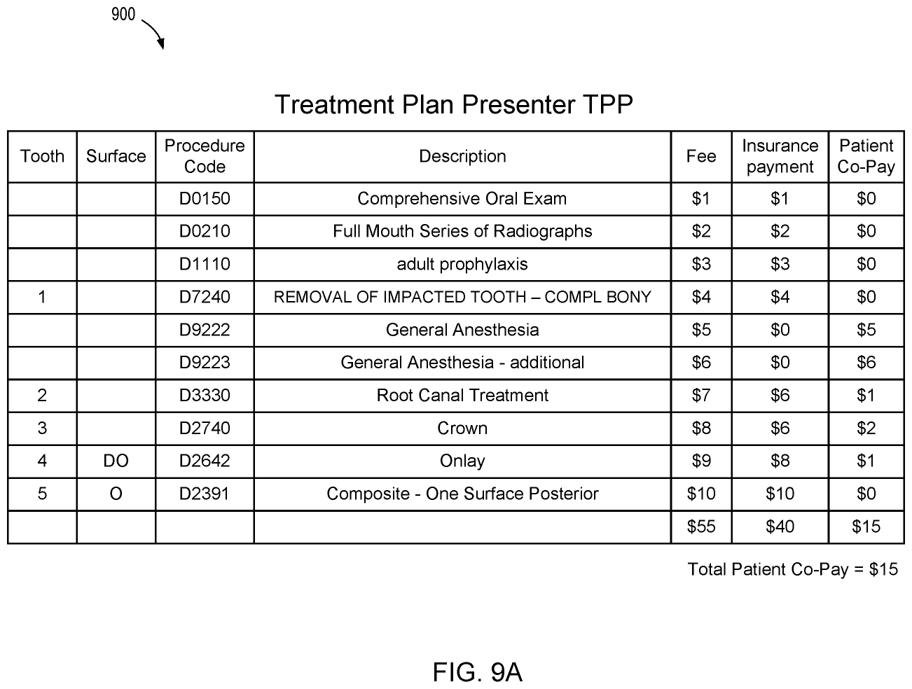

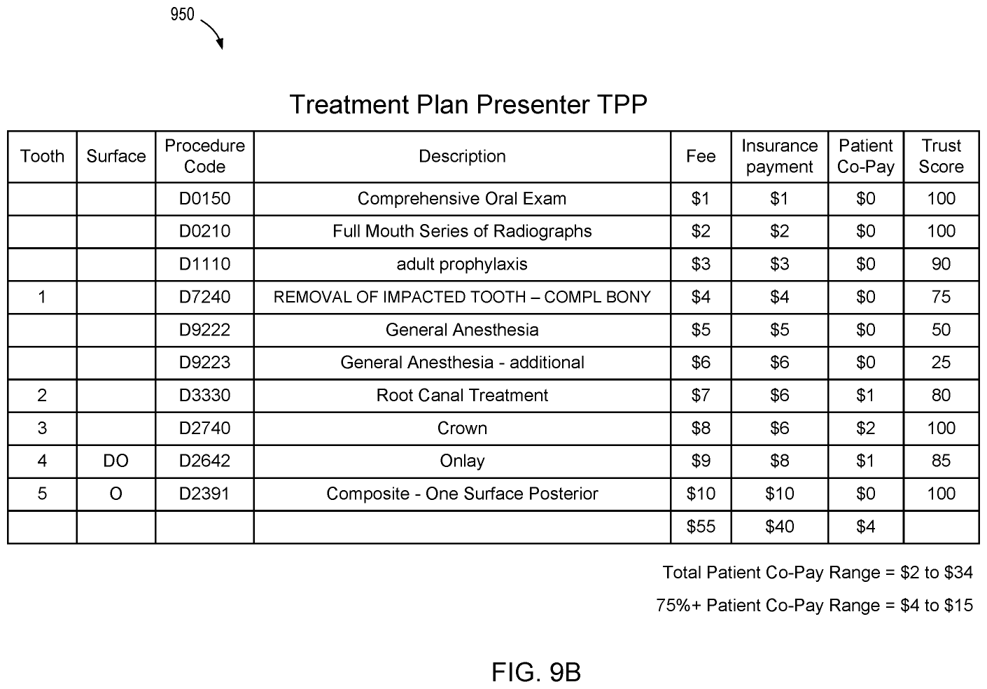

FIG. 9A illustrates an example of a treatment plan 900 generated by a treatment plan presenter (TPP), according to one embodiment. The TPP also offers advanced features such as but not limited to: allowing the dental office staff to alter the treatment, select a different specialist, rearrange the order of the treatment to maximize the insurance benefits for the most needed procedures or based on the provider or patient's desires. The TPP could be used instead of the ORKS treatment plan presenter or could pull from the ORKS to create the TPP or any combination thereof.

FIG. 9B illustrates an example of another treatment plan 901 prepared by a treatment plan presenter (TPP) with co-pay ranges based on associated trust scores, according to one embodiment. As illustrated, some of the line items are associated with trust scores less than 100. The trust scores in the examples range from 0 to 100, but any numerical range, letter grade, percentage, color coding scheme, or other comparative assignment may be used instead of a 0-100 numerical range.

According to various embodiments, a trust score may be based on what information is verified, confirmation of the accuracy of the information, the possibility of holding the provider of the data accountable for errors, etc. For example, data received from an insurance company may be associated with different levels of confidence, that may factor into the trust score, based on a range of factors and quality of sources. An example spectrum of accuracy for data retrieval sources might include phone calls to the insurance company, electronic verification using existing e-verify tools, post hoc verification of past claims, faxback information, online portals, API requests, insurance representative conversations, externally accessible databases, and learned data based on prior claim processing.

A trust score may be based on the quality or confidence level associated with the data obtained from insurance carriers and/or specialists. The treatment plan presented may use coverage estimate information with a trust score above a certain threshold value and assume a worst-case scenario for those coverage estimates associated with a trust score below a threshold value. In other embodiments, the treatment plan may provide a range of possible cost estimates and coverage amounts in conjunction with percentages of likelihood or transparent trust score estimates associated with each value.

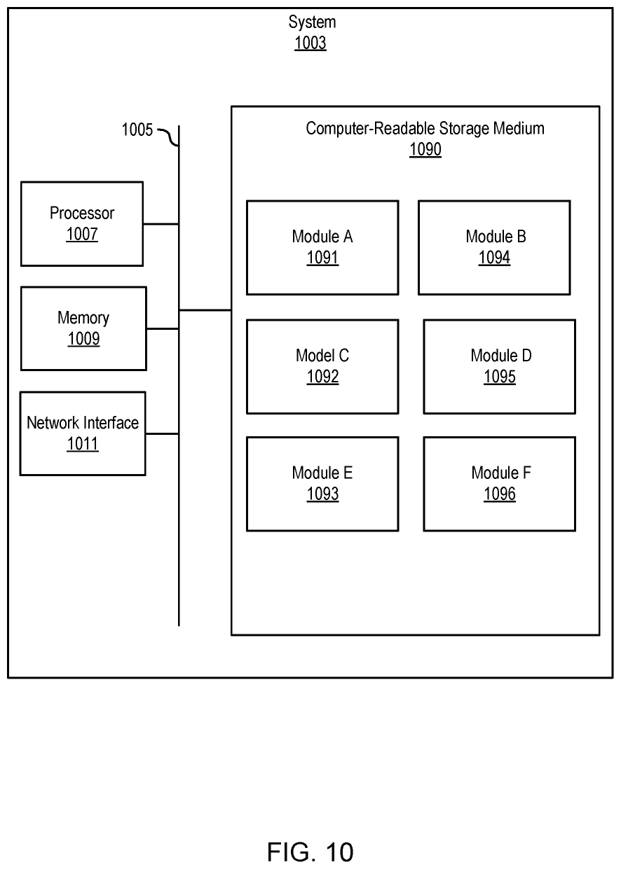

FIG. 10 illustrates a block diagram of one implementation of various embodiments of the system 1003 described herein in which any combination of the named components, functional components, systems, subsystems, or modules is implemented as a module within a computer-readable medium for execution by a processor, according to one embodiment. As illustrated, a bus 1005 may connect a processor 1007, memory 1009, and a network interface 1011 to a non-transitory computer-readable storage medium 1090 with various modules 1091-1096. Each of the modules may implement one or more of the operations, steps, systems, and subsystems described herein.

For example, Module A 1091 may comprise a DCL module to aggregate data from various insurance companies. Module B 1092 implements the DCL to aggregate data from various specialists. Module C 1093 is a single series array module to generate SSA and CCC data structures, as described herein. Module D 1094 may be a treatment plan presented (TTP) module to generate treatment plans. Module E 1094 may be a trust score generation module to generate a trust score and/or associate received data with a confidence score or individual trust score based on the source of the data and/or comparison with previously processed claims in a processed claim database.

According to one example, a system includes a processor, a memory, a database of processed dental insurance claims that includes information identifying at least coverage and patient copay amounts for a plurality of dental procedures, and a non-transitory computer-readable medium with stored instructions. The instructions, when executed by the processor may cause the system to identify a plurality of dental procedures to be performed on a patient. The system may then obtain insurance coverage information from a first insurance provider of the patient for the identified dental procedures using a first type of data retrieval source (e.g., email, electronic request, API, phone call and manual entry into a database, lookup table on a website, insurance card information, etc.).

The system may obtain insurance coverage information from a second insurance provider of the patient for the identified dental procedures using a second type of data retrieval source (e.g., a different source or the same source). The system may then calculate a co-pay amount that the patient will have to pay for each of the dental procedures based on the insurance coverage information obtained from the first and second insurance providers.

The system may then generate a trust score for each of the calculated co-pay amounts for each dental procedure based on the types of data retrieval sources used to obtain the insurance coverage information from the first and second insurance providers for each of the identified dental procedures. As described herein, some sources may be considered very accurate while other sources may be less reputable or otherwise associated with a lower confidence level for a given treatment or dental procedure.

The system may then compare the calculated co-pay amounts with historical co-pay amounts of previously processed insurance claims for the identified dental procedures in the database of processed dental insurance claims for other patients with the same dental insurance coverage by the first and second insurance providers.

The system may adjust the calculated trust score for each of the calculated co-pay amounts based on the comparison of the calculated co-pay amounts with the historical co-pay amounts for each of the identified dental procedures. For example, the trust score may be increased or stay maximized when the historical co-pay amounts match. Similarly, when the amounts do not match the trust score may be decreased.

The system may then calculate an adjusted co-pay amount, a range of co-pay amounts, worst-case and best-case amounts, or the like for each of the identified dental procedures as a function of the respective calculated co-pay amounts and the respective adjusted trust score amounts.

The system may then generate a treatment plan (e.g., as part of a graphical user interface), as a printout report, as an electronic report, as part of an email, as part of a contract, or the like. The treatment plan may include identification of the dental procedures to be performed, a total expected cost of each of the dental procedures, coverage amounts to be paid by one or both or the combination of the insurance companies, and/or a portion of the total expected cost of each of the dental procedures to be paid for by the patient based on the adjusted co-pay amount of each of the identified dental procedures. The amount to be paid by the patient may be presented as a specific value (e.g., dollar amount), a range of amounts, a best-case amount, a worst-case amount, or as an amount or range coupled with a confidence level.

For example, the amount could be presented as “The expected co-pay amount is between $250 and $1,000. We are confident that the amount will be at least $250, but there is a low/fair/high probability that the amount will be as much as $1,000. We are confident that the total amount of the co-pay will not exceed $1,000.” Simpler approaches may be used without so much detail and qualitative words like low, fair, high may correspond to specific threshold numerical values of the adjusted trust score.

It is understood that aspects of the systems and methods described herein can implement or perform one or more of the following: sync data between computers which use non similar languages, exchanges data between first insurance carrier and dental office, sync data between first insurance carrier and dental office, create a DCL that grabs/converts first insurance carrier data into a standard format which can be shared with dental office, create a DCL that syncs data between first insurance carrier and dental office, create a DCL that exchanges data between first insurance carrier and dental office, grab information from dental insurance companies' databases and syncs them to dental office practice management software system, possibly access the full insurance contract of the patient, grab information from dental insurance companies' databases and exchanges it with dental office practice management software systems, grab member benefit information from dental insurance companies' databases and syncs them to dental office practice management software systems, grab member benefit information from dental insurance companies' databases and exchanges it with dental office practice management software systems, grab ALL ADA code information from dental insurance companies' databases and sends them to doctor practice management software systems, grab ALL ADA code information from dental insurance companies' databases and syncs them to provider practice management software systems, create a DCL that grabs/converts insurance company data into a standard format that syncs with a dental practice management systems, create a DCL that grabs/converts insurance company data into a standard format and exchanges it with a dental practice management systems, create a DCL that allows the insurance companies to opt in to send their data in a standard format, create a DCL that allows the insurance companies to opt in to exchange their data in a standard format, create a DCL that allows the insurance companies to opt in to sync their data in a standard format, and/or implement or perform other actions and operations described herein.

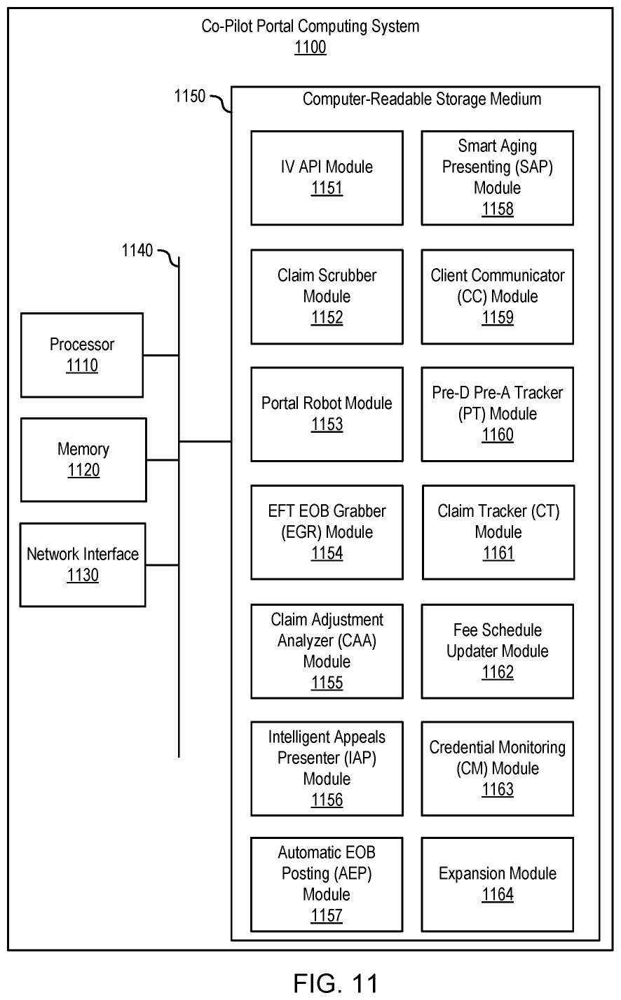

FIG. 11 illustrates a co-pilot portal computing system 1100, according to one embodiment. As illustrated, each of the functionalities described herein may be implemented as instructions stored on a non-transitory computer-readable medium 1150 that, when executed by the processor 1110 in conjunction with the memory 1120 and network interface 1130 connected by the bus 1140, cause the co-pilot portal computing system 1100 to implement the various functionalities described herein. In various embodiments, the modules 1151-1164 may additionally include or be alternatively implemented as application specific integrated circuits (ASICs), via programmable logic devices, and/or other hardware computing components.

The co-pilot portal computing system 1100 provides numerous benefits to dental office personnel, dental office owners, dental office management platforms, dental office service providers, and the like. For example, the co-pilot portal computing system 1100 enables a practice to work more efficiently by utilizing machine learning to implement learned “best practices.” The co-pilot portal computing system 1100 may allow less-skilled employees to manage some of the dental office functions and/or reduce their learning curve so that they can be more efficient. For example, the co-pilot portal computing system 1100 may allow employees to accomplish many of the tasks that previously required a highly skilled employee who is familiar/comfortable with claims and calling insurance carriers/patients. Thus, the co-pilot portal computing system 1100 allows an employee to accomplish the tasks and perform the functions of an employee with years of training, skills, and/or experience.

The specific functionalities are described in greater detail below in conjunction with the associated bottlenecks and problems to be solved. However, in the context of the presently described architecture, the computer-readable storage medium 1150 includes an IV API module 1151. a claim scrubber module 1152, a portal robot module 1153, an EFT EOB grabber (EGR) module 1154, a claim adjustment analyzer module 1155, an intelligent appeals presenter module 1156, an automatic EOB posting module 1157, a smart aging presenting module 1158, a client communicator module 1159, a pre-D pre-A tracker module 1160, a claim tracker module 1161, a fee schedule updater module 1162, a credential monitoring module 1163, an expansion module 1164, and/or any combination or permutations of the aforementioned modules or subsets of the aforementioned modules.

The various subsystems, modules, and connections with external components illustrated and described in conjunction with FIG. 11 and the other architectures illustrated herein form the technical solutions to the identified deficiencies, problems, and bottlenecks addressed by the co-pilot portal system 1100. Each of the technical solutions is described in terms of one or more bottlenecks addressed by the technical solution. The technical solutions provided for increased efficiency, reduced computing power consumptions, reduced compute resource requirements, and centralized computer architectures that reduce waste and are more easily managed.

The IV API module 1151 is described in detail above in conjunction with FIGS. 1-10 as, among other things, managing claim submissions and estimates when multiple insurance carriers are involved.

The claim scrubber module 1152 manages claim submissions to ensure correct documentation, evidence, and information is provided in each submitted claim. Claims submitted with incorrect information, missing information, extraneous information, duplicate information, and/or the like result in delayed, underpaid, or unpaid claims. The claim scrubber module 1152, as described herein, gathers necessary information, identifies missing information, and compiles documentation and chart notes in advance of claim submissions. As described herein, the claim scrubber module 1152 may utilize machine learning techniques to process claims and improve on claims processing over time. For example, if a claim is being submitted for a periodontal procedure, the claim scrubber module 1152 would automatically ensure that a full mouth series of x rays, a narrative, and a periodontal charting is attached to the electronic claim before it is submitted so that the claims meet all necessary requirements. The claim scrubber module 1152 may collect all the information needed from the dental office PMS system and/or prompt a user to add any missing information that is identified as required by an insurance carrier to review and pay the claim.

According to some embodiments, the system may facilitate the inclusion of custom, patient-specific chart notes as part of a claim. The narrative for the claim may be easily customizable for each patient and for each treatment. A template for generating such a claim may include dropdown menu items to facilitate the creation of a custom claim. The system may identify potential errors and/or provide suggestions for improving a claim in real-time during the claim creation process. As opposed to having a post-claim-creation review process (as might have been done by humans in the past), the real-time review and feedback process allows for a highly efficient claim generation process that results in an acceptable claim being created the first time. For example, the system may detect that a code used in a claim during the creation process does not match the keywords in the narrative or chart notes associated with the claim. The system may suggest alternative claim codes that match the narrative or chart notes. For example, the system may pose questions during claim creation such as, but not limited to: “Is this what you mean?” or “Did you intend to use this code?,” or “It seems like you wanted to include . . . .”

A portal robot module 1153 improves the submission of insurance claims through clearinghouses. Currently, many dental offices submit insurance claims through a clearinghouse which makes the process of submitting the claims fast and easy, but often requires the dental office to wait 2-3 weeks to receive the insurance payment and forces the dental office to pay a fee for each claim submitted. The portal robot module 1153 facilitates the automatic or guided submission of insurance claims via existing insurance portals of various insurance carriers. The portal robot module 1153 allows the dental office to receive payment much faster, maybe as soon as a few days, and there is often no fee for using the insurance portal.

Although utilizing the insurance portal is a superior way to submit claims, they are only used approximately 3% of the time on average because they can take up to an hour to manually submit a claim via the insurance portal compared to 10 seconds when using a clearinghouse. The portal robot module 1153 may automatically submit claims through the insurance portal instead of using a clearinghouse. The portal robot module 1153 runs automatically, thereby saving the dental office staff the 1-4 hours per day while also reducing errors and allowing the dental office to receive payment sooner. The portal robot module 1153 pulls the required documents from connected databases and/or a connected dental practice management system, attaches the documents to the claim, and automatically submits the documents via the insurance portal of each different insurance carrier in seconds so that the insurance carrier has all they require to review and pay the claim.

The electronic funds transfer explanation of benefits (EFT EOB) grabber module 1154 enhances the existing explanation of benefits process. When a dental office submits an insurance claim to an insurance carrier, the insurance carrier often creates an EFT EOB. Whereas paper EOBs are mailed to the dental office, EFT EOBs are normally manually retrieved by dental office personnel and may be done via a web portal. For example, the dental office must log into the insurance portal and manually download the EFT EOBs, which can take an office 1-2 hours daily depending on the volume of claims. The EFT EOB grabber module 1154 automatically grabs all EFT EOBs from the insurance portal for quick and easy access. The EFT EOBs may be saved within a database of the co-pilot practice portal system 1100 and/or within the dental office PMS.

A claim adjustment analyzer module 1155 improves claim adjustment and appeal processes. Insurance companies create insurance packages which they offer to employers outlining what the insurance carrier will cover for each of the hundreds of American Dental Association's Current Dental Terminology (ADA CDT) codes. Insurance companies offer a breakdown of benefits, maximum allowable charges, deductibles, maximum benefits, etc. that define each available “insurance plan” with great specificity. Once an employer decides which insurance plan to purchase, the role of the insurance company is to administer the benefits of the insurance plan that the employer purchased. To do so, the insurance company must follow a specific set of standards (the “Plan Document”) that is outlined in the insurance policy which the employer purchased.

When a dental office submits an insurance claim to a dental insurance carrier, the carrier may “adjust” the payments based on the Plan Document design. For example, if a dental office submits an ADA CDT code for an implant for tooth #8 (maxillary, right, central, incisor) with a charge of $3,000, the Plan Document may be permitted to offer an alternate benefit (AB) of a removable partial denture (RPD) with a fee of $1,000 if certain criteria are met (e.g., more than one missing tooth in the arch). Therefore, instead of the dental office receiving an insurance payment based on a fee of $3,000, they will receive a payment from the insurance company based on a fee of $1,000.

The dental office must know when a claim is adjusted so that they can know what they are permitted to charge the patient and/or if they want to challenge/appeal the adjustment. Unfortunately, many offices are so busy that it is difficult for them to know when a carrier adjusts the claim, how much the adjustment is, and when they should challenge/appeal the claim. Sometimes “adjustments” to ADA code payouts should not be accepted by the dental office. Unfortunately, far too many adjustments are accepted that should or could be appealed, which results in the dental office and/or patient losing a substantial amount of money.

The claim adjustment analyzer module 1155 automatically reviews claims and pulls those for which an adjustment has been made by the insurance carrier, highlights those that should be appealed based on a history of shared learning of similar claims that have successfully been appealed. The adjusted claims may be saved, summarized, and/or reported to the dental office with recommendations for appeal when applicable.

The intelligent appeals presenter module 1156, provides an automatic and/or guided appeal process for appealing adjustments or denials of claims. When a dental insurance carrier “adjusts” a claim which the dental office submitted for reimbursement, the dental office can decide to appeal the adjustment. As described above, the claim adjustment analyzer module 1155 pulls the claims that have been adjusted, analyzes the claims, and provides a list of claims that the dental office should appeal. The dental office is now faced with the challenge of knowing how to appeal the adjustment properly and provide the required documentation so they can reduce the number of appeals and length of the appeal process. The dental office must know what to say and what documents to present to the insurance carrier.

Some dental offices need to appeal claims multiple times (e.g., 2-4 times) to get the carrier to finally pay the proper amount. The intelligent appeals presenter module 1156 automatically instructs the dental office what documents to provide, suggests language to include, and helps the dental office appeal claims based on what it has learned over history from other successful appeals and saves them into a connected database system and/or dental office PMS.

For example, the dental office may submit a claim for an implant for tooth #8. The insurance may provide an alternative benefit of a removable partial denture because more than one tooth is missing in the arch, stating teeth #5, 8, and 12 are missing. The intelligent appeals presenter module 1156 selects this adjusted claim and recommends the dental office submit an appeal and state: “Teeth #5 and #12 were extracted and the space closed during orthodontic treatment due to crowding in the arch. Therefore, the only space in the arch is due to the extraction of tooth #8. Therefore, please re-process the claim and pay based on the $3,000 submitted for an implant to replace tooth #8.” This appeal would prevent the dental office from losing $2,000.

As described above, the claim adjustment analyzer module 1155 automatically creates a list of all the adjustments that should be challenged and then sends the claims to the intelligent appeals presenter module 1156 for analysis. The intelligent appeals presenter module 1156 analyzes the claims and recommends the proper documents and responses to send to the insurance carrier for each different claim.

The automatic EOB posting module 1157 posts explanations of benefits claims, credits, and debits to each patient's financial ledger. In some instances, when a dental office submits an insurance claim to a dental insurance carrier, the carrier processes the claim and creates an EOB. Many times, dental offices must manually post EOB debits and credits to a patient's financial ledger which is prone to human error and mistakes and is quite time-consuming. The automatic EOB posting module 1157 automatically collects all EOBs from the insurance carrier and saves them in a connected database, which then installs or syncs them accurately into the dental office PMS. The automatic EOB posting module 1157 subsystem or module may save the dental office staff 2-4 hours per day while also reducing errors and allowing the dental office to verify that payment/credits have been received.

Despite efforts by the American dental association, there is no law or requirement that insurance companies provide EOBs with any level of consistency or common terminology. For example, one EOB may refer to an “allowed amount” while another might refer to only a patient's responsibility, and yet another might refer to the combined total of the patient's obligations and the insurance coverage amount. A trained machine learning model can be used to detect the different terminologies and formatting of the EOBs for normalization and comparison. Research indicates that 19% of EOBs are inaccurate, and it is widely accepted that EOBs are difficult to read A dental practice loses money when neither patients nor dental practices understand or closely review EOBs. The presently described systems and methods check for accuracy and facilitate trust building between practitioners and patients by helping the practitioners identify errors.

The smart aging presenting module 1158, manages accounts receivable in an organized manner. Managing the accounts receivable in a dental office can be overwhelming and, especially when done manually, can result in collection errors. Manual tracking of accounts receivable aging can be inefficient, susceptible to user mistakes, result in missed appeals, result in failures to timely file documentation, and/or result in delays in payment for the dental office or client. The smart aging presenting module 1158 offers insights, suggestions, and reports relating to the outstanding aging by timely filing, last worked, etc. The insights, suggestions, and/or reports may be saved in a connected database, presented to dental office personnel, and/or saved in the dental office PMS. This may save the dental office staff 1-2 hours per day while also reducing errors and allowing the dental office to precisely know the status of the aging reports.

The client communicator module 1159, provides an interactive, real-time, dashboard/interface that clients can access from their desktop and/or their mobile device. The client communicator module 1159 can be user-configured to show the data most relevant to them: stats from the other subsystems and modules to report in real-time, daily, weekly, monthly, yearly, or a customized time schedule to offer a snapshot of their success.

The pre-D pre-A tracker module 1160 manages preauthorization requests with insurance carriers. Dental offices may desire to offer their patients treatment plans with the various options and fees associated with each so the patient can make an informed (e.g., the most fiscally responsible) health care decision. Often, the dental office may send a pre-determination (Pre-D) and/or a pre-authorization (Pre-A) request to an insurance carrier so the dental office and patient will know how the carrier will reimburse for a procedure or procedures. Often, insurance carriers do not respond in a timely manner, the insurance carrier does not have the required documentation from the dental office, and/or the dental office may not remember to follow up with the insurance carrier. These oversights may result in a delay in patient treatment or a patient who appoints for a procedure without the dental office having the Pre-D and Pre-A response from the insurance carrier, which will result in an unproductive visit for the patient and the dental office.

The pre-D pre-A tracker module 1160 scans pre-determination and pre-authorization requests from the dental office and tracks them for the dental office to review and/or for input into the dental office PMS. The pre-D pre-A tracker module 1160 may save the dental office staff 1-2 hours per day trying to find, keep track of, and follow up on all the pre-authorizations and determinations. The pre-D pre-A tracker module 1160 not only keeps track of the pre-authorizations/determinations so the office can be efficient but also tracks what they were and what the final payments are when received from the insurance carrier. In some embodiments the pre-D pre-A tracker module 1160 also alerts the dental office if an appeal is recommended.

For example, returning to the example above in which a claim was submitted for an implant (ADA CDT code D6010) for tooth #8. The system correctly identified the claim should be appealed and recommended how to appeal, and the insurance company then approved the implant for #8.

The pre-D pre-A tracker module 1160 may then track that pre-authorization and alert the dental office the carrier has failed to respond. The dental office will then follow up with the carrier which states that the carrier will pay 80% and the patient 20%. Upon completion of the implant, the claim is submitted for reimbursement. The carrier paid $1,000 and now states the patient's responsibility is $2,000. The pre-D pre-A tracker module 1160 will then select this claim for review stating that the EOB does not match the pre-authorization and will alert the dental office to investigate and/or automatically submit an appeal to the insurance carrier and automatically attach the pre-authorization, the EOB, supporting documentation, and state the nature of the appeal as, for example: “Carrier did not honor the pre-authorization amount, please remit full payment.”

The pre-D pre-A tracker module 1160 records the D6010 pre-authorization did not match the EOB so the system can utilize this information to report the success rate of the pre-authorization for this code and this insurance carrier. The system will then score the ADA CDT code as “x”% reliability in pre-authorizations based on the history of all D6010 pre-authorizations vs EOB comparisons, as well as “x”% reliability for the D6010 for insurance carrier “y”, as well as “z”% reliability for carrier “y”. As the pre-D pre-A tracker module 1160 reviews more claims, the system will become more accurate at predicting the success rate for pre-authorizations for the ADA CDT code, code-carrier, and carrier. This data will then be used to present to the dental office when a new pre-auth/determination is sought.

For example, revisiting the claim for an implant (ADA CDT code D6010) for tooth #8, the dental office might create the pre-authorization and the system will show a success rate of 80% for the ADA CDT code (D6010), a 60% for a D6010 for Insurance Carrier Y, and 75% for Insurance Carrier Y overall, which the dental office can share with the patient so the patient can better understand why there may be a discrepancy when the EOB is received. Currently, there is no way for an office to make this prediction which leaves the patient and the dental office at odds after treatment has been completed if the money owed by the patient is more than what was originally predicted.

Additionally, Pre-D and Pre-A may only be valid for a certain time period when received from the Insurance Carrier. The pre-D pre-A tracker module 1160 may be configured to keep track of this timing and alert the user at preset intervals when the Pre-D and Pre-A will expire. This process will greatly enhance the dental office's ability to complete treatment in a timely manner before the expiration date so the office has the best chance of knowing what the costs will be and receiving said reimbursement.

The claim tracker module 1161, facilitates claim tracking on an ongoing basis. Dental offices must submit their claims to the insurance carrier in order for the carrier to review/process, provide the insurance payment portion, and provide an EOB so the dental office knows how much the patient's financial obligation is. Sometimes dental offices use dental insurance claim clearinghouses to help send the insurance claims. By way of example, a dental office may see 50 patients who have dental insurance in one day. Sometimes patients have similar insurance carriers, but often the 50 insurance claims must be delivered to different insurance companies A-Z.

A dental office may send all 50 claims to a single clearinghouse to handle delivery to each different insurance company. The clearinghouse may process the claims with the different insurance companies A-Z. The dental office must track the claims that were sent and follow up on any that have been delayed. A time-consuming task for the dental office is to research and discover why a claim is delayed. Sometimes it can be delayed because of the clearinghouse. Often, insurance carriers delay the process because they do not have the required documentation from the dental office to process the claim. The dental office must know which claims to follow up on and remember to do so.

The claim tracker module 1161 scans claims sent by the dental office, including claims sent through an insurance portal, sent electronically through a clearinghouse, or mailed as a hard copy. The claim tracker module 1161 tracks the claims for the dental office to review in the system or within the dental office PMS. The claim tracker module 1161 saves the dental office staff 1-2 hours per day trying to find, keep track of, and follow up on all the claims submitted. In some embodiments, the claim tracker module 1161 also tracks the amount of the office fee request and the final payment from the insurance carrier. The claim tracker module 1161 may also alert the dental office if an appeal is recommended.

The fee schedule updater module 1162, updates fee schedules associated with various procedures and insurance companies. Dental offices should evaluate their fee schedules often and update them routinely. Additionally, some dental offices have contracted fees schedules with dental insurance carriers which the carrier routinely updates. If a dental office allows a long period of time to lapse and fails to update their fee schedule and/or update their contracted fee schedules with all the insurance carriers they contract, they can undercharge for procedures and lose a tremendous amount of money. Furthermore, the more insurance carriers a dental office contracts with, the more cumbersome a task fee schedule updating can be which causes the fee schedule updates to lapse often for years.

The fee schedule updater module 1162 scans the fee schedules in the dental office PMS, compares them to the insurance carrier, automatically updates them as needed in the dental office PMS, and alerts the dental office to make the dental office aware of and appreciate the savings and/or additional revenue provided. The FSU subsystem or module also alerts the dental office if the dental office's master fee schedule has not been updated yearly or at another predefined time interval set by the user. The FSU will then automatically update and balance fees based on the dental office geographical location once prompted.

The fee schedule updater module 1162, alerts the dental office if it discovers that an insurance carrier fee schedule updated fee is higher than the dental office's master fee schedule so that the dental office can make the adjustment. For example, if the dental office's master fee schedule states a dental cleaning is $50 but the FSU subsystem or module discovers that Insurance Company “A” updated the dental cleaning to reimburse at $60, the dental office would be losing out on $10 for each cleaning it performs since the insurance carrier is only obligated to pay the dental office for the lesser of the amount the dental office charges or the insurance carrier charges.

A credential monitoring module 1163 maintains proper provider credentials. When a dental provider in a dental office contracts with a dental insurance carrier, all dental providers who will be treating patients from the insurance carrier must be credentialed for each insurance carrier for which they are contracted. For example, if Dr. A (DA) contracts with insurance company 1 (I1), DA must be credentialed with I1 before DA can get reimbursed for treating any I1 patients. If Dr. B (DB) works in DA's office but is NOT contracted with I1, then DB cannot be reimbursed for treating any patients from I1. Additionally, if DA fails to renew his/her credentials with I1, then DA cannot be reimbursed from I1 for treating any of I1's patients.

The credential monitoring module 1163 scans the insurance companies with which the dental office is contracted and ensures that each provider is properly credentialed with the insurance carrier and creates an alert for claims that have a provider experiencing credentialing issues so that the dental office can address the credentialing concerns.

In the example cited above, perhaps DB's name was recorded as treating the I1 patient, when in fact, DA treated the patient, the CM subsystem or module would catch this and allow the dental office to double-check to make the change. If the CM subsystem or module did not notify the dental office of the credentialing mismatch, then I1 would deny payment of the claim or pay the claim as an out-of-network provider both of which would cause confusion and make more work for the dental office to rectify.

The expansion module 1164 allows for future expansion of the ecosystem and interoperability between existing modules.

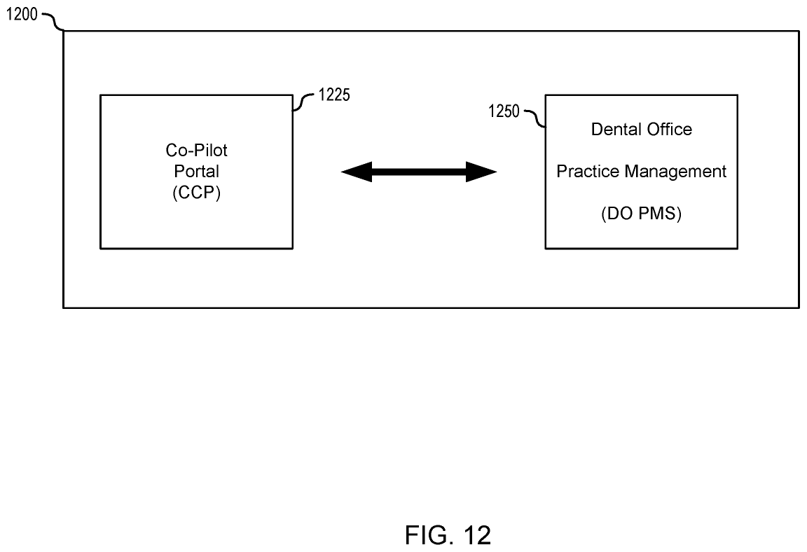

FIG. 12 illustrates a block diagram 1200 of co-pilot portal computing system 1225 interacting with a dental office practice management system 1250, according to one embodiment.

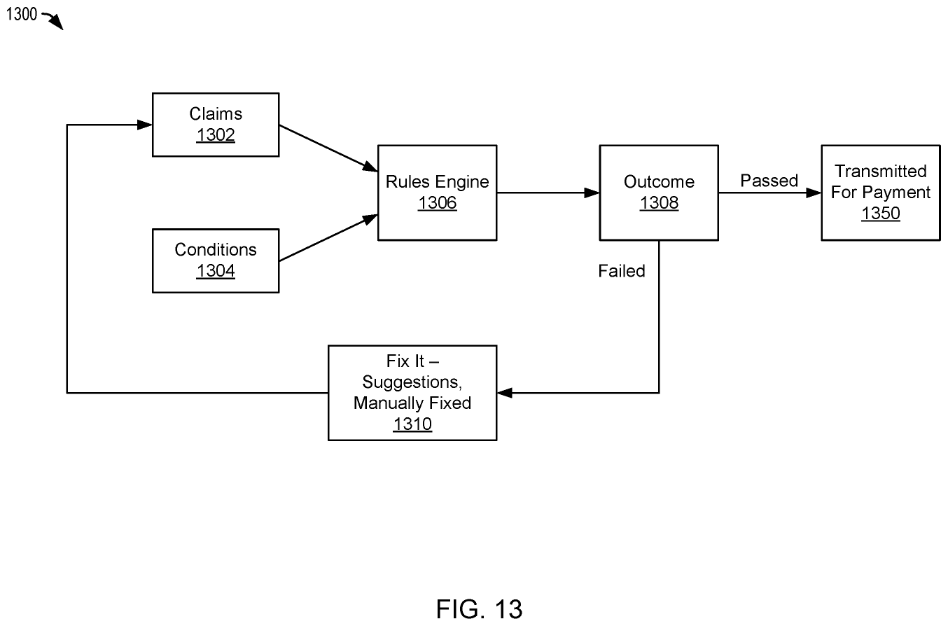

FIG. 13 illustrates a block diagram of a claim scrubber system 1300 with conditions-based rules engine processor, according to one embodiment. As illustrated, a rules engine 1306 receives claims for submission to an insurance company (e.g., via a clearing house or via an insurance companies dedicated insurance portal) along with conditions 1304 that define the requirements for each claim for each insurance company (e.g., documentation, rules, codes, required information, etc.). Many of the conditions 1304 may be specified by the insurance company, manually obtainable by phone call, accessible in printed literature, available via an API, or otherwise provided by the insurance company.

Other conditions 1304 may be manually added by office personnel based on the collective knowledge of processing claims using legacy systems and approaches. For example, providers or dental office assistants may add manual conditions to limit submissions to certain days of the week, to avoid holiday submissions, to always include specific information that might not be required, but appears to result in faster processing in some instances, etc.

In some embodiments, the claim scrubber system 1300 evaluates a claim at the time a claim is submitted for payment. The claim scrubber system 1300 may determine that a claim is approved and complete the submission, or determine that the claim is deficient or otherwise unlikely to be paid for another reason. As described herein, the claim scrubber system 1300 may modify the claim and/or provide recommendations or suggestions for modifying the claim to increase the likelihood of payment.

In other embodiments, the claim scrubber system 1300 is triggered and evaluates a claim at the time the claim is created. Evaluating the claim at the time of claim creation allows the original creator of the claim to evaluate any suggested modifications at the time of creation. In such an embodiment, all saved claims are ready for submission, having either been approved by the claim scrubber system 1300, revised/updated by the claim creator, and/or manually approved by the claim creator despite any rejections or suggestions made by the claim scrubber system 1300.

The rules engine 1306 compares the claims with the conditions 1304 and generates an expected outcome 1308. The rules engine 1306 may indicate a claim is likely to be paid and so has “passed” the analysis and can be transmitted for payment 1350. Alternatively, the rules engine 1306 may indicate a claim is deficient or otherwise likely to be unpaid or rejected. Failed claims may not be transmitted for payment 1350 unless a human manually overrides the process and submits the claim for payment. In some embodiments, the claim scrubber system 1300 identifies or suggests corrections, updates, documents, evidence, and/or other changes or modifications that could be made to the claim to improve the likelihood of payment. The claim scrubber system 1300 may allow for the claim to be manually, or in some instances, automatically fixed, at 1310, to become a new claim 1302 to be re-analyzed and processed by the rules engine 1306.

The claim scrubber system 1300 can identify, based on particular carrier and dental billing codes, exactly what needs to be submitted (e.g., the conditions 1304) for the claim to be paid. In some instances, the rules engine 1306 can identify the information that is needed from within connected databases and automatically modify or update the claim. Some automatically updated/modified claims may be transmitted for payment 1350 without any further review or human intervention. For example, if the claim was missing a patient's personal information, a date, a dental code was entered incompletely, or otherwise contained a factual error, the rules engine 1306 may automatically update the claim using information in a connected database, the dental office practice management system, and/or practice notes relating to a particular procedure in the claim. In other instances, specific changes to a claim may require human verification and validation before being transmitted for payment 1350.

ADA CDT codes are updated annually. As such, treatment proposed in CDT code format within a dental office software for a patient seen in December could no longer be relevant when the patient returns in January to have treatment completed. The system recognizes any ADA CDT code additions, deletions, and/or revisions and remaps the outdated code to the up-to-date and current ADA CDT code.

For example, the ADA CDT code to report Guided Tissue Regeneration—Resorbable Barrier, per site (otherwise known as a resorbable membrane) in 2022 is D4266. The ADA's Code Maintenance Committee recognized the various common uses of guided tissue regeneration and approved three distinct code sets effective Jan. 1, 2023; one set for each of these uses. D6106 is specifically for GTR around an implant using a resorbable barrier. If a GTR-resorbable membrane is placed in conjunction with natural teeth (osseous surgery), report D4266. If a GTR-resorbable membrane is placed in conjunction with a bone socket graft, sinus lift, or edentulous area, report D7956. If a GTR-resorbable membrane is placed in conjunction with periradicular surgery, report D3432. The system identifies these code changes and either identifies the claim for review by a human for correction/confirmation or replaces the ADA CDT code automatically based on information in the clinical chart notes.

With changes expected in the future to the ADA CDT code set and claim submission process which would incorporate consistent and required usage of International Classification of Diseases (ICD) diagnosis codes and modifiers similar to that of the current medical claim submission process, the system also incorporates these changes either automatically or by way of a drop down selection process to ensure accurate and timely dental claim submission. This change will impact dental offices in that most dental offices are unfamiliar with diagnosis codes or modifiers or how to apply them. Artificial Intelligence and/or machine learning technologies track how these changes impact the claim submission process and which diagnosis codes and modifiers result in fewer claim denials, rejections, and appeals; as well as reimbursement rates for individual payors (insurance companies) so treatment plans can be presented accurately and patients can make informed healthcare and financial decisions.

As another example, a periodontal cleaning must have historical cleaning information attached to the claim to be paid. The rules engine 1306 may determine that the claim for the periodontal cleaning does not include the required historical active treatment information, flag the claim or prompt a user to provide the required information and update the claim. The rules engine can identify duplicate codes that are likely to be rejected. For example, an initial x-ray and an additional x-ray on the same day may require the use of different codes. If the initial claim used the same code, the rules engine 1306 may flag the claims as being duplicative and suggest that either (1) one of the claims be deleted as an accidental duplicate or (2) that the ADA code for the second x-ray be updated to indicate that it was an additional x-ray.

As another example, the rules engine 1306 may identify missing codes or errors based on a patient's age. Even if the patient's age is not in the claim being analyzed, the rules engine 1306 can access the provider's PMS to determine the age of the patient and provide improved scrutiny and analysis. As an example, the system 1300 may include conditions 1304 specifying that “crown codes” are not payable for patients under the age of 13. The system may correct the age provided on in the claim to match the age in the PMS system and/or identify the claim for review by a human for correction/confirmation. As another example, the conditions 1304 may specific that anesthesia cannot be billed by itself due to insurance requirements and/or that it should not be billed by itself because it is indicative of a missing claim for the accompanying procedure. That is, even if the insurance company has no policy against billing anesthesia by itself, it is likely that another procedure was performed for which a claim should be submitted.

As another example, the rules engine 1306 may evaluate a claim and determine that it satisfies the conditions 1304 specified by insurance companies (e.g., insurance company conditions), but that additional conditions 1304 for faster payment may be applicable (e.g., practice-specific conditions). For example, claims for x-rays and cleanings may be paid quickly, while claims for a crown may be paid more slowly. While the insurance company conditions 1304 may allow for a combined claim that includes all three procedures, the practice-specific conditions may require or recommend that the claims be split into two (or three) different claims to facilitate the quickest possible payment for each claim. Thus, the system 1300 may automatically split the claim into two or three different claims and submit them (assuming all other information is correct) and/or flag the claim (or updated/recommended claim) for review and approval before submission.

In various embodiments, the claim scrubber system 1300 may manipulate the claim, patient, insurance, etc. while PMS is down. In such instances, the claim scrubber system 1300 tracks all changes in the order such changes were made. Once the PMS is working again, the claim scrubber system 1300 updates the PMS to ensure that the claim scrubber system (and other aspects of the co-pilot portal system) are synchronized. The ordered changes are made to ensure that the two systems remain identical after the sync updates. In various embodiments, the system 1300 may utilize a client-installed lightweight version of the open-source project Debezium to facilitate real-time and time-synchronous syncing between databases even when one of them is offline for a period of time.

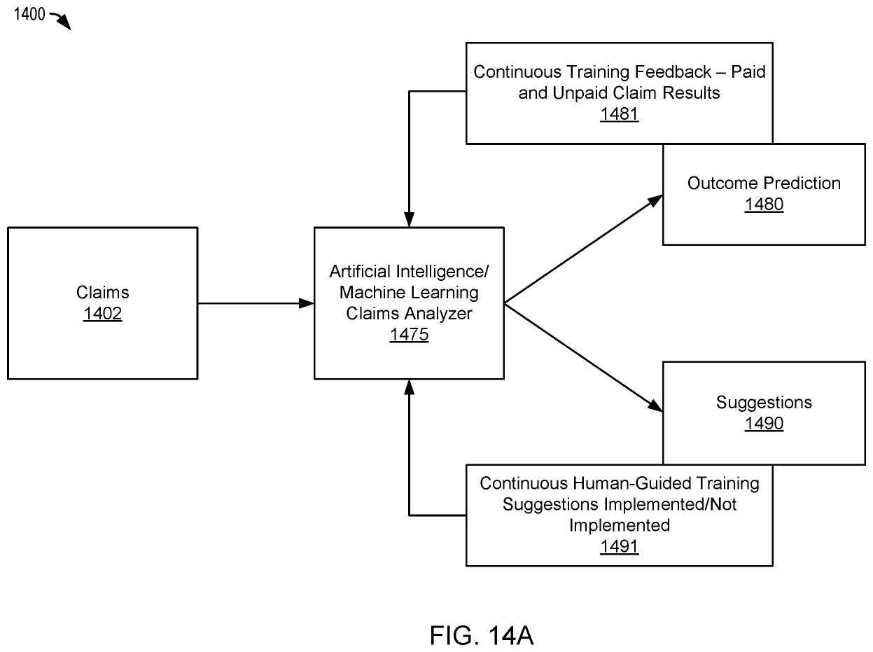

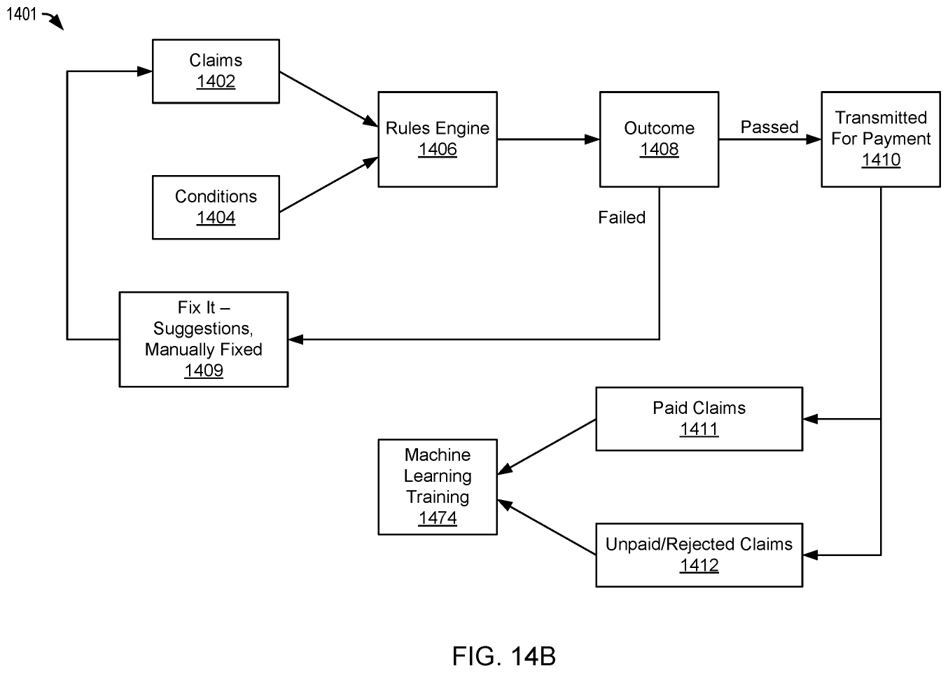

FIG. 14A illustrates a block diagram of a machine-learning claim scrubber system 1400 of a co-pilot portal system, according to one embodiment. As illustrated, claims 1402 are received by an artificial intelligence or machine learning claims analyzer 1475 that is trained to generate an outcome prediction 1480 and, in some instances, suggestions 1490 for ways to improve the likelihood of claim payment. The outcome prediction may, for example, be provided in a pass or fail format, or may indicate a percentage of likelihood that the claim will be processed and paid by the insurance company.

Claims that are associated with a positive outcome prediction 1480 may be transmitted for payment without modification. The results of such submissions (i.e., the claims are paid or unpaid/rejected) is used as continuous training feedback 1481 and fed back into the machine learning claims analyzer 1475. In addition to the outcome accuracy feedback, the machine learning claims analyzer 1475 may also receive human-guided training relative to the suggestions 1490 that are made. That is, the machine learning model of the claims analyzer 1475 may be trained based on suggestions 1490 that are implemented by a human reviewer and suggestions 1490 that are not implemented or marked as “bad suggestions.” Over time, the machine learning claims analyzer improves both the outcome prediction 1480 and the suggestions 1490 for improving the claim submission.

FIG. 14B illustrates a block diagram of a claim scrubber system 1401 with a conditions-based rules engine processor 1406 used to train a machine learning model 1474, according to one embodiment. The upper portion of the diagram is similar to that described in conjunction with FIG. 13. Specifically, a rules engine 1406 receives and processes claims 1402 in view of conditions 1404. The conditions 1404 may be any of those described herein, including those described in conjunction with FIG. 13.

The outcome 1408 of the rules engine 1406 predicts the likelihood that the claim will be submitted. Claims 1402 that are determined to have a high likelihood of a poor outcome 1408 may be fixed, at 1409, and reprocessed. Claims 1402 that pass the analysis by the rule engine 1406 and are associated with a positive outcome 1408 prediction are transmitted or payment, at 1410.

Those claims that are ultimately paid 1411 and claims which are unpaid, partially paid, or rejected 1412 are fed into a machine learning model along with the original claims, fixes/edits/modifications made based on the rules engine 1406 suggestions. In addition, the machine learning model 1474 may be trained based on the amount of time taken for a claim to be processed and paid by the insurance carrier. The machine learning model 1474 may receive and consider as inputs all patient information, all treatment information, all information provided with the claim submitted to the insurance carrier, the timing of payment, modifications to the payments, rejections, reasons for rejections, and/or other information relating to each submitted claim. Once trained, a trained machine learning model 1475 (FIG. 14A) may be utilized as described herein.

In one embodiment, the rules engine 1406 and a trained machine learning model 1475 (FIG. 14A) may be used in tandem. In such an embodiment, the claims may be processed automatically when they satisfy both the trained machine learning model and the rules engine analyses. If a claim fails to pass either analysis, the claim may be flagged for review by a human reviewer. The human reviewer may be presented with suggestions to modify the claim provided by the rules engine 1406 and/or the trained machine learning system 1475.

Some of the infrastructure that can be used with embodiments disclosed herein is already available, such as: general-purpose computers, computer programming tools and techniques, digital storage media, and communications networks. A computer may include a processor, such as a microprocessor, microcontroller, logic circuitry, or the like. The processor may include a special-purpose processing device, such as an ASIC, a PAL, a PLA, a PLD, a CPLD, a Field Programmable Gate Array (FPGA), or other customized or programmable device. The computer may also include a computer-readable storage device, such as non-volatile memory, static RAM, dynamic RAM, ROM, CD-ROM, disk, tape, magnetic, optical, flash memory, or other computer-readable storage medium.

Suitable networks for configuration and/or use, as described herein, include any of a wide variety of network infrastructures. Specifically, a network may incorporate landlines, wireless communication, optical connections, various modulators, demodulators, small form-factor pluggable (SFP) transceivers, routers, hubs, switches, and/or other networking equipment.

The network may include communications or networking software, and may operate using TCP/IP, SPX, IPX, SONET, and other protocols over twisted pair, coaxial, or optical fiber cables; telephone lines; satellites; microwave relays; modulated AC power lines; physical media transfer; wireless radio links; and/or other data transmission “wires.” The network may encompass smaller networks and/or be connectable to other networks through a gateway or similar mechanism.

Aspects of certain embodiments described herein may be implemented as software modules or components. As used herein, a software module or component may include any type of computer instruction or computer-executable code located within or on a computer-readable storage medium, such as a non-transitory computer-readable medium. A software module may, for instance, comprise one or more physical or logical blocks of computer instructions, which may be organized as a routine, program, object, component, data structure, etc., that perform one or more tasks or implement particular data types, algorithms, and/or methods.

A particular software module may comprise disparate instructions stored in different locations of a computer-readable storage medium, which together implement the described functionality of the module. Indeed, a module may comprise a single instruction or many instructions, and may be distributed over several different code segments, among different programs, and across several computer-readable storage media. Some embodiments may be practiced in a distributed computing environment where tasks are performed by a remote processing device linked through a communications network. In a distributed computing environment, software modules may be located in local and/or remote computer-readable storage media. In addition, data being tied or rendered together in a database record may be resident in the same computer-readable storage medium, or across several computer-readable storage media, and may be linked together in fields of a record in a database across a network.

The various functional components of the described systems and methods may be modeled as a functional block diagram that includes one or more remote terminals, networks, servers, data exchanges, and software/hardware/firmware modules configured to implement the various functions, features, methods, and concepts described herein. In many instances, each application, embodiment, variation, option, service, and/or other component of the systems and methods described herein may be implemented as a module of a larger system. Each module may be implemented as hardware, software, and/or firmware, as would be understood by one of skill in the art for the particular functionality and may be part of a larger physical system that may include computer-readable instructions, processors, servers, endpoint computers, and/or the like.

The embodiments of the disclosure can be understood by reference to the drawings, wherein like parts are designated by like numerals throughout. The components of the disclosed embodiments, as generally described and illustrated in the figures herein, could be arranged and designed in a wide variety of different configurations. Further, those of skill in the art will recognize that one or more of the specific details may be omitted, or other methods, components, or materials may be used. In some cases, operations are not shown or described in detail. Thus, the detailed description of the embodiments of the systems and methods of the disclosure is not intended to limit the scope of the disclosure, as claimed, but is merely representative of possible embodiments.

1-7. (canceled)

8. A claim scrubber system, comprising:
a database of processed dental insurance claims that includes at least:
a set of processed dental insurance claims rejected by an insurance company, and
a set of processed dental insurance claims accepted by an insurance company;
a claim analyzer subsystem comprising a machine learning model trained on the database of processed dental insurance claims and configured to:
receive an input dental insurance claim for evaluation, and
generate, using the trained machine learning model, a predicted payment outcome score indicating a likelihood that an insurance company will pay the evaluated dental insurance claim;
a display subsystem to render, for display on an electronic display, the predicted payment outcome score associated with the evaluated dental insurance claim; and
a machine learning model feedback subsystem to:
determine, after submission of the evaluated dental insurance claim, a payment status of the submitted dental insurance claim as being paid, partially paid, or unpaid by the insurance company, and
provide, as training feedback to the machine learning model of the claim analyzer subsystem, the submitted dental insurance claim and the payment status of the submitted dental insurance claim to improve predicted payment outcome scoring of subsequently provided dental insurance claims.

9. The system of claim 8, wherein the predicted payment outcome score comprises a numerical value between 0 and 100.

10. The system of claim 8, wherein the claim analyzer subsystem is further configured to:
identify the input dental insurance claim as a deficient dental insurance claim in response to a predicted payment outcome score below a threshold value; and
generate a notification alerting an operator that the input dental insurance claim is a deficient dental insurance claim.

11. The system of claim 10, wherein the claim analyzer subsystem is further configured to:
determine a possible modification that could be made to the dental insurance claim;
reevaluate, using the trained machine learning model, the dental insurance claim with the possible modification made to determine a modified predicted payment outcome score; and
in response to the modified predicted payment outcome score being higher than the predicted payment outcome score, provide the operator with a suggestion to make the possible modification.

12. The system of claim 8, further comprising an integration subsystem to access a dental office practice management system (PMS) via a communications network.

13. The system of claim 12, wherein the claim analyzer subsystem is further configured to:
identify the input dental insurance claim as a deficient dental insurance claim due to missing information;
access the dental office PMS to obtain the missing information;
automatically update the input dental insurance claim with the missing information; and
reevaluate, using the trained machine learning model, the updated dental insurance claim to determine an updated predicted payment outcome score for the updated dental insurance claim.

14. The system of claim 12, wherein the claim analyzer subsystem is further configured to:
identify the input dental insurance claim as a deficient dental insurance claim due to missing information;
access the dental office PMS to obtain the missing information;
generate a notification with a suggestion that an operator add the missing information to the input dental insurance claim;
receive an updated dental insurance claim modified by the operator to include the missing information; and
reevaluate, using the trained machine learning model, the updated dental insurance claim to determine an updated predicted payment outcome score for the updated dental insurance claim.

15. A method of scrubbing dental insurance claims, comprising:
accessing a database of processed dental insurance claims from multiple independent dental offices;
training a machine learning model on the database of processed dental insurance claims to predict a payment outcome score for input dental insurance claims, where the predicted payment outcome score of each dental insurance claim indicates a likelihood of payment;
evaluating, via the machine learning model, a first plurality of dental insurance claims for a first dental office to determine a predicted payment outcome score for each of the first plurality of dental insurance claims;
evaluating, via the machine learning model, a second plurality of dental insurance claims for a second dental office to determine a predicted payment outcome score for each of the second plurality of dental insurance claims;
receiving payment outcome information from the first dental office for at least some of the first plurality of dental insurance claims submitted by the first dental office; and
receiving payment outcome information from the second dental office for at least some of the second plurality of dental insurance claims submitted by the second dental office.

16. The method of claim 15, further comprising:
providing, as training feedback to the machine learning model, payment outcome information for dental insurance claims submitted by the first and second dental offices;
continuously retraining the first machine learning model with the payment outcome information from the first and second dental offices; and
evaluating, via the continuously retrained machine learning model, subsequently provided dental insurance claims from both the first dental office and the second dental office.

17. The method of claim 15, further comprising:
providing, as training feedback to the machine learning model, the payment outcome information from the first dental office;
retraining the machine learning model with the payment outcome information from the first dental office to develop a first locally customized machine learning model for the first dental office;
providing, as training feedback to the machine learning model, the payment outcome information from the second dental office;
retraining the machine learning model with the payment outcome information from the second dental office to develop a second locally customized machine learning model for the second dental office;
evaluating, via the first locally customized machine learning model, subsequently provided dental insurance claims from the first dental office; and
evaluating, via the second locally customized machine learning model, subsequently provided dental insurance claims from the second dental office.

18. The method of claim 17, wherein the first dental office comprises a first specialist type and the second dental office comprises a second specialist type, and
wherein the first locally customized machine learning model is customized via the training feedback for evaluations relating to the first specialist type and the second locally customized machine learning model is customized via the training feedback for evaluations relating to the second specialist type.

19. The method of claim 17, wherein the first dental office submits claims to a first set of insurance carriers and the second dental office submits claims to a different, second set of insurance carriers, and
wherein the first locally customized machine learning model is customized via the training feedback to generate predicted payment outcome scores with respect to the first set of insurance carriers and the second locally customized machine learning model is customized via the training feedback to generate predicted payment outcome scores with respect to the second set of insurance carriers.

20. The method of claim 15, wherein the database of processed dental insurance claims includes processed dental insurance claims from different insurance carriers.

21. The method of claim 15, wherein the wherein the predicted payment outcome score comprises a numerical value between 0 and 100.

22. The method of claim 15, further comprising:
identifying input dental insurance claims with predicted payment outcome scores indicating a likelihood of being rejected; and
suggesting, to an operator, a modification to be made to at least one of the identified dental insurance claims to increase the predicted payment outcome score.

23. A system, comprising:
a claim analyzer subsystem with a machine learning model trained on a general database of processed dental insurance claims from multiple independent dental offices configured to:
determine a predicted payment outcome score for an input dental insurance claim, and
determine a suggested modification to the input dental insurance claim that is predicted to increase the predicted payment outcome score;
a feedback subsystem to receive feedback including:
modification feedback indicating whether a user accepted the suggested modification to the dental insurance claim prior to submission to an insurance carrier, and
outcome feedback indicating whether the dental insurance claim was paid by the insurance carrier; and
a training subsystem to continuously train the machine learning model using the received modification feedback and outcome feedback to improve determinations of predicted payment outcome scores and suggested modifications of subsequently input dental insurance claims.

24. The system of claim 23, wherein the training subsystem is configured to:
develop a first local machine learning model for a first dental office by continuously training the machine learning model using (a) outcome feedback from the first and second dental offices and (b) modification feedback from only the first dental office, such that the first local machine learning model is trained to determine predicted payment outcomes based on a global training dataset and determine suggested modifications based on a local training dataset of the first dental office; and
develop a second local machine learning model for the second dental office by continuously training the machine learning model using (a) outcome feedback from the first and second dental offices and (b) modification feedback from only the second dental office, such that the second local machine learning model is trained to determine predicted payment outcomes based on a global training dataset and determine suggested modifications based on a local training dataset of the second dental office.

25. The system of claim 23, wherein the wherein the predicted payment outcome score comprises at least one of: a numerical value, a letter grade, and a pass or fail format.

26. The system of claim 23, further comprising an integration subsystem to access a dental office practice management system (PMS) via a communications network, and wherein the claim analyzer subsystem is further configured to:
identify information missing from the dental insurance claim;
access the dental office PMS to obtain the missing information; and
automatically augment the dental insurance claim with the missing information.

27. The system of claim 23, further comprising an integration subsystem to access a dental office practice management system (PMS) via a communications network, and wherein the claim analyzer subsystem is further configured to:
identify information missing from the dental insurance claim;
access the dental office PMS to obtain the missing information; and
include the missing information as part of the determined suggested modification.
